(19) United States
(12) Patent Application Publication
(10) Pub. No.: US 2019/0147430 A1
(43) Pub. Date: May 16, 2019

(54) CUSTOMIZING PAYMENT SESSIONS WITH MACHINE LEARNING MODELS

(71) Applicant: Apple Inc., Cupertino, CA (US)

(72) Inventors: Shuohui Chen, Irvine, CA (US); David L. Neumann, Lake Oswego, OR (US); Eric J. Gray, Sunnyvale, CA (US); Fei Gao, San Francisco, CA (US); Lincoln L. Barker, San Francisco, CA (US); Michael K. Chu, Cupertino, CA (US); Payam Mirrashidi, Los Altos, CA (US); Timothy Russo, San Francisco, CA (US); Todd J. Fitzgerald, San Francisco, CA (US); Wayne A. Yap, San Francisco, CA (US); Yichen Liu, San Jose, CA (US); Yu Liu, Los Altos, CA (US); Bilung Lee, San Jose, CA (US); Mingzhu Zhu, Sunnyvale, CA (US)

(21) Appl. No.: 16/189,546

(22) Filed: Nov. 13, 2018

Related U.S. Application Data
(60) Provisional application No. 62/584,563, filed on Nov. 10, 2017.
(60) Provisional application No. 62/689,671, filed on Jun. 25, 2018.

(51) Int. Cl. G06Q 20/22; G06K 9/62; G06F 15/18

(52) U.S. Cl. CPC G06Q 20/22; G06F 15/18; G06K 9/6259

(57) ABSTRACT

Systems, methods, and computer-readable media are provided for customizing payment sessions.

### CROSS-REFERENCE TO RELATED APPLICATIONS

This application claims the benefit of prior filed U.S. Provisional Patent Application No. 62/584,563, filed Nov. 10, 2017, and of prior filed U.S. Provisional Patent Application No. 62/689,671, filed Jun. 25, 2018, each of which is hereby incorporated by reference herein in its entirety.

### TECHNICAL FIELD

This disclosure relates to customizing payment sessions and, more particularly, to customizing the eligibility, time limit, value amount limit, and/or session utility viability of a payment session for aggregating transactions between a service provider subsystem and a customer with machine learning models.

### BACKGROUND OF THE DISCLOSURE

A customer may conduct multiple service transactions with a service provider (e.g., multiple purchases of goods/services of an online media store) using a transaction credential managed by a credential manager (e.g., a payment instrument of a financial institution), and the service provider may aggregate all service transactions conducted during a payment session into a single aggregated transaction before sending an authorization request for the aggregated transaction to the credential manager. Such a payment session is often pre-defined to have a specific time limit or a specific aggregated transaction value amount limit that is not based on actual customer behavior.

### SUMMARY OF THE DISCLOSURE

This document describes systems, methods, and computer-readable media for customizing payment sessions.

As an example, a method is provided for customizing a payment session using a management server that includes defining, with the management server, a first historical session to include a first historical transaction of a historical transaction timeline of a historical user, defining, with the management server, a second historical session to include the first historical transaction and a second historical transaction of the historical transaction timeline, wherein the second historical transaction is consecutively after the first historical transaction in the historical transaction timeline, after the defining the second historical transaction, determining, with the management server, if a session utility value of the defined second historical session is greater than a historic session utility threshold, when it is determined that the session utility value of the defined second historical session is greater than the historic session utility threshold, labeling, with the management server, the defined second historical session as a negative label and the defined first historical session as a positive label, obtaining, with the management server, a first set of model input features for the defined first historical session and a second set of model input features for the defined second historical session, and, after the labeling and the obtaining, training a session utility model, with the management server, using the label and the set of model input features of at least one of the defined first historical session and the defined second historical session.

As another example, a non-transitory machine readable medium is provided storing a program for execution by at least one processing unit of a management server, the program for customizing a payment session, the program including sets of instructions for carrying out a transaction sessionization subprocess for a historical payment session including two or more consecutive historical transactions of a historical transaction timeline of a historical user to determine a utility of the historical payment session, carrying out a feature and label extraction subprocess for the historical payment session to determine a label of the historical payment session based on the determined utility of the historical payment session and to identify one or more features of the historical payment session, and carrying out a training subprocess to train a session utility model using the determined label of the historical payment session and the one or more identified features of the historical payment session.

As yet another example, a system is provided for customizing a payment session, including a credential manager subsystem that manages a payment credential, a service provider subsystem that offers a product, and a user electronic device that attempts a new purchase of the product of the service provider subsystem, for a user of the user electronic device, using the payment credential, wherein the service provider subsystem is configured to detect the new purchase attempt, in response to the detection of the new purchase attempt, determine that there is an active payment session for the user, and, in response to the determination of the active payment session, run a trained session utility model on one or more features of the new purchase attempt to predict a probability of a utility of continuing the active payment session.

This Summary is provided only to present some example embodiments, so as to provide a basic understanding of some aspects of the subject matter described in this document. Accordingly, it will be appreciated that the features described in this Summary are only examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The discussion below makes reference to the following drawings, in which like reference characters refer to like parts throughout, and in which:

FIG. 1 is a schematic view of an illustrative system for customizing payment sessions;

FIG. 2 is a more detailed schematic view of an example electronic device of the system of FIG. 1;

FIG. 3 is a front view of the example electronic device of FIGS. 1 and 2;

FIG. 4 is a more detailed schematic view of the example service provider subsystem of the system of FIG. 1;

FIG. 5 is a more detailed schematic view of an illustrative portion of the example service provider subsystem of the system of FIGS. 1 and 4;

FIGS. 6 and 7 are flowcharts of illustrative processes for customizing payment sessions;

FIG. 7A is a flowchart of an illustrative process for determining training data for a session utility model; and

FIG. 7B is a timeline of exemplary historical transaction data that may be used for determining training data for a session utility model.

### DETAILED DESCRIPTION OF THE DISCLOSURE

Systems, methods, and computer-readable media may be provided for customizing payment sessions. Service transactions conducted between a service provider and a customer using a customer transaction credential managed by a credential manager during such a payment session may be aggregated prior to the service provider requesting authorization of the aggregated transactions. A goal may be to customize the eligibility, time limit, value amount limit, and/or idle time of a payment session afforded by the service provider to a customer for reducing the risk associated with the loan(s) of aggregated transactions of the payment session while also increasing the number and/or pendency of the payment sessions provided by the service provider (e.g., to reduce transaction fees and/or operation traffic that may be associated with requesting transaction authorization, and/or to provide a more efficient and seamless user experience). A payment session time limit and/or a payment session value amount limit and/or a session utility probability may be identified using one or more payment session models based on particular transaction data associated with a particular customer and a particular transaction purchase attempt, such that the handling of an active payment session may be personalized to a particular customer and/or different types of payment sessions may be afforded to different customers and/or different payment sessions may be afforded to a particular customer over time based on that particular customer's behavior. In some embodiments, certain characteristics of a payment session may be dynamically changed during the pendency of that payment session based on new real-time data that may be made available to the system. Use of one or more machine learning models may enable a data driven model for customizing a payment session as opposed to a pre-defined payment session, a dynamically refreshable active payment session as opposed to a static payment session, and/or a probability based payment session as opposed to a rule based payment session.

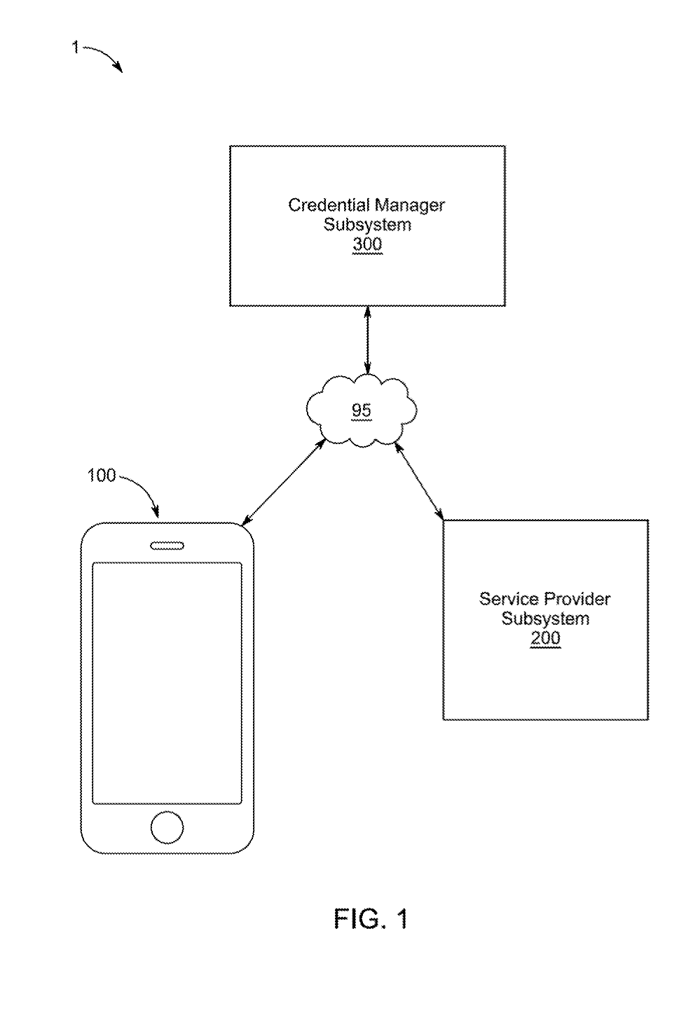

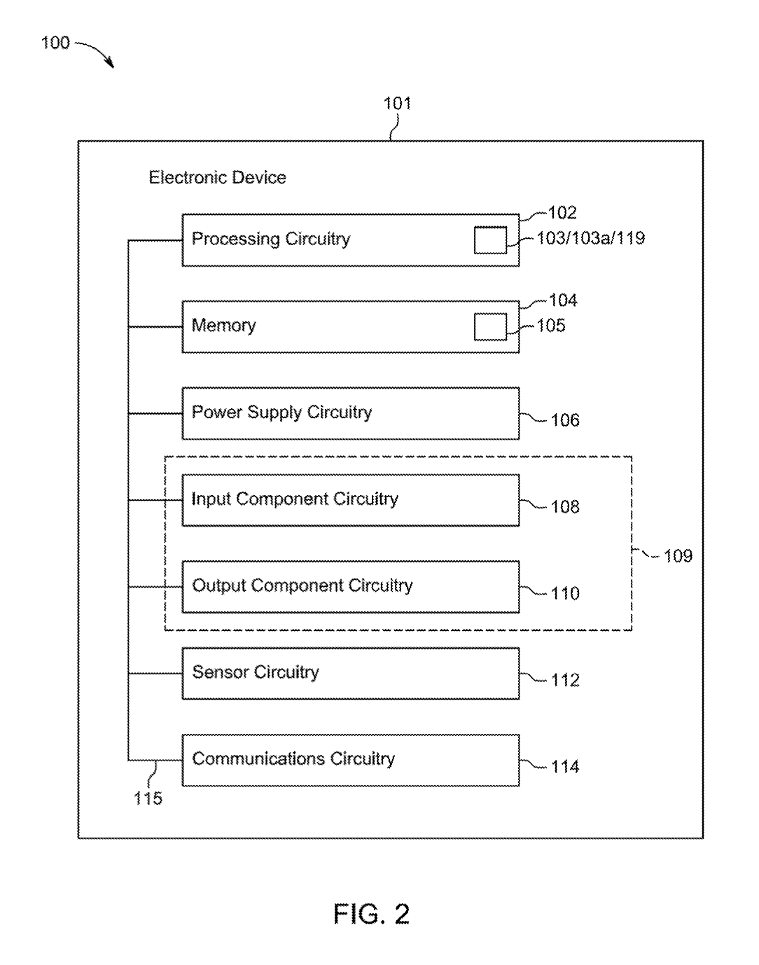

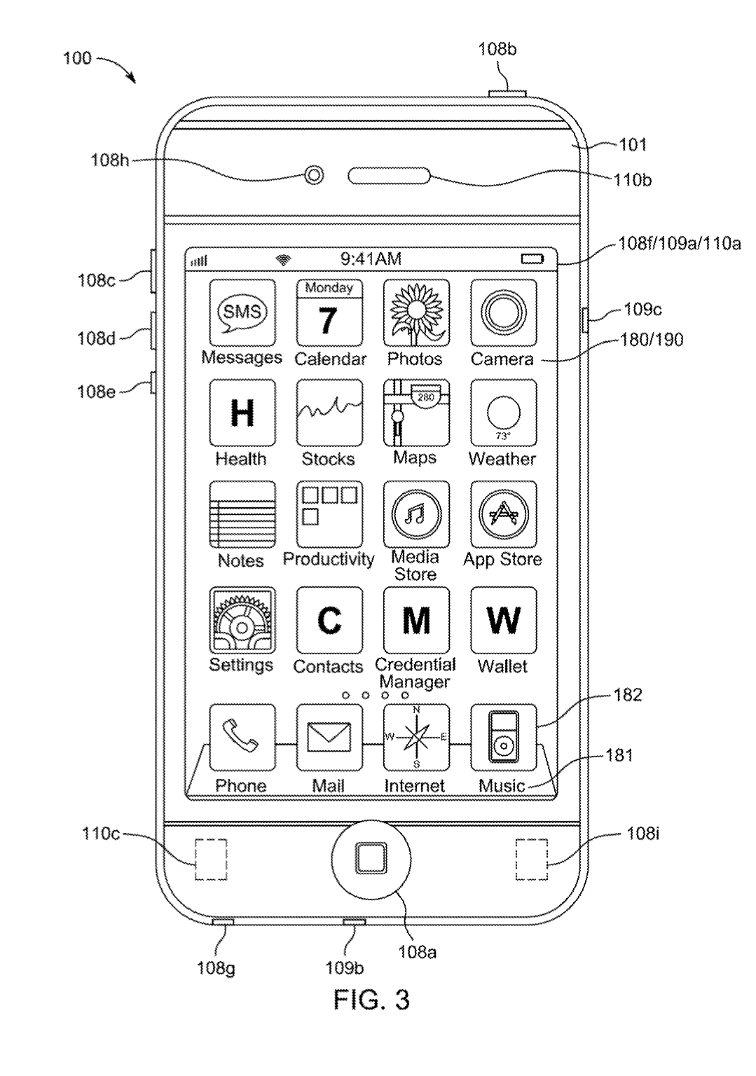

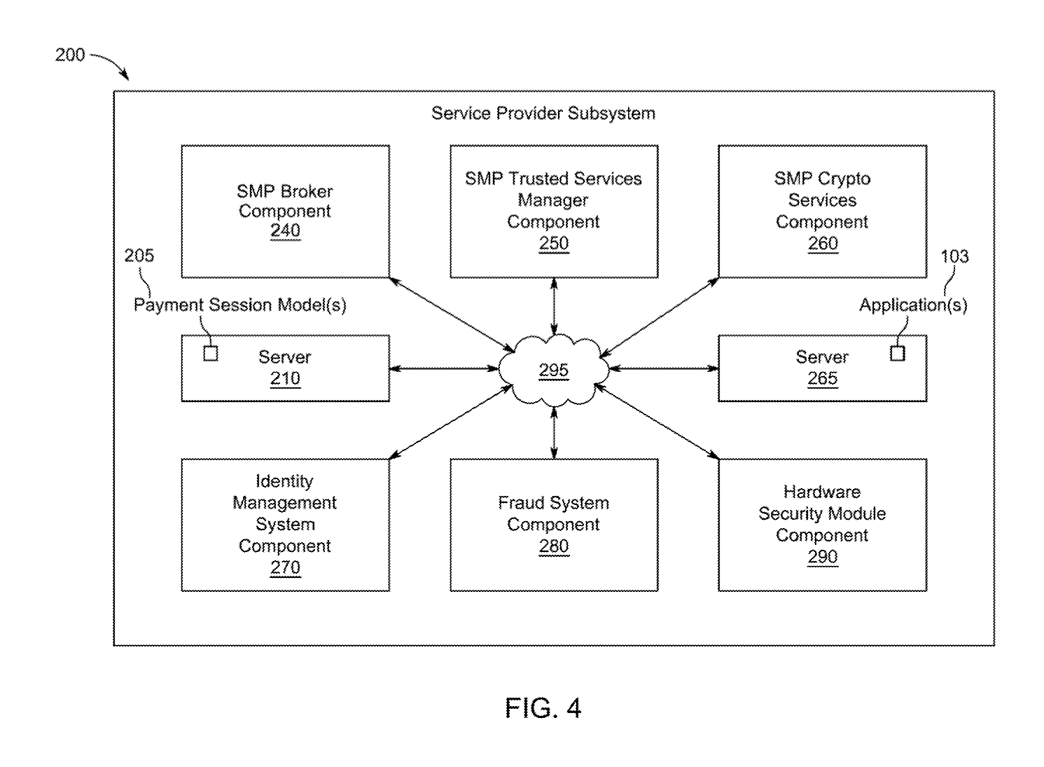

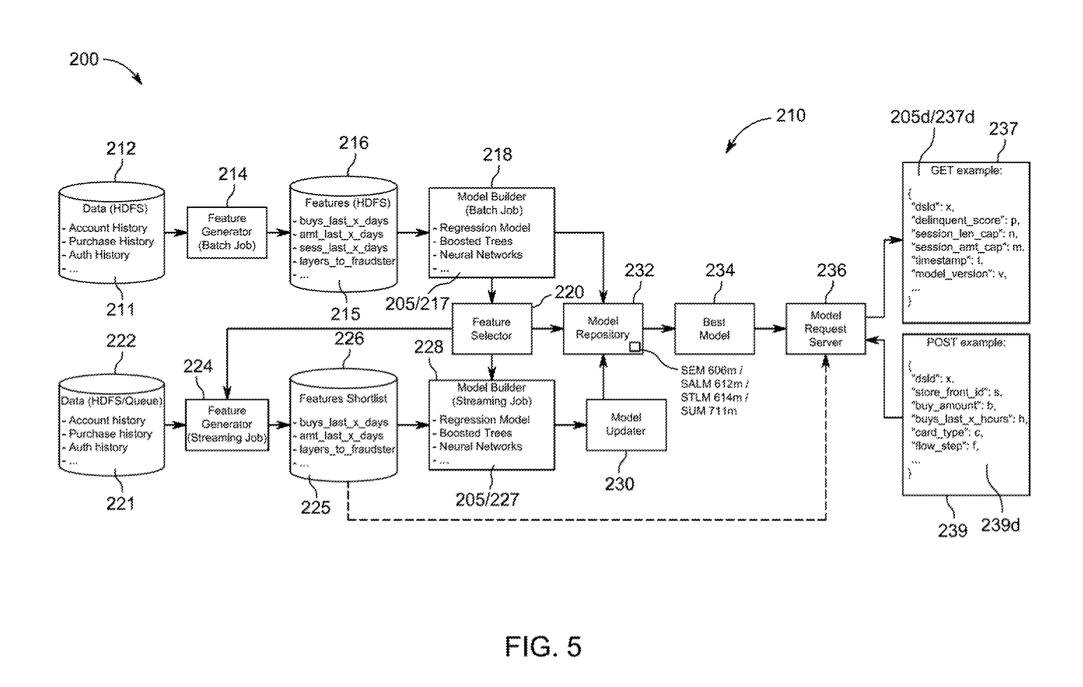

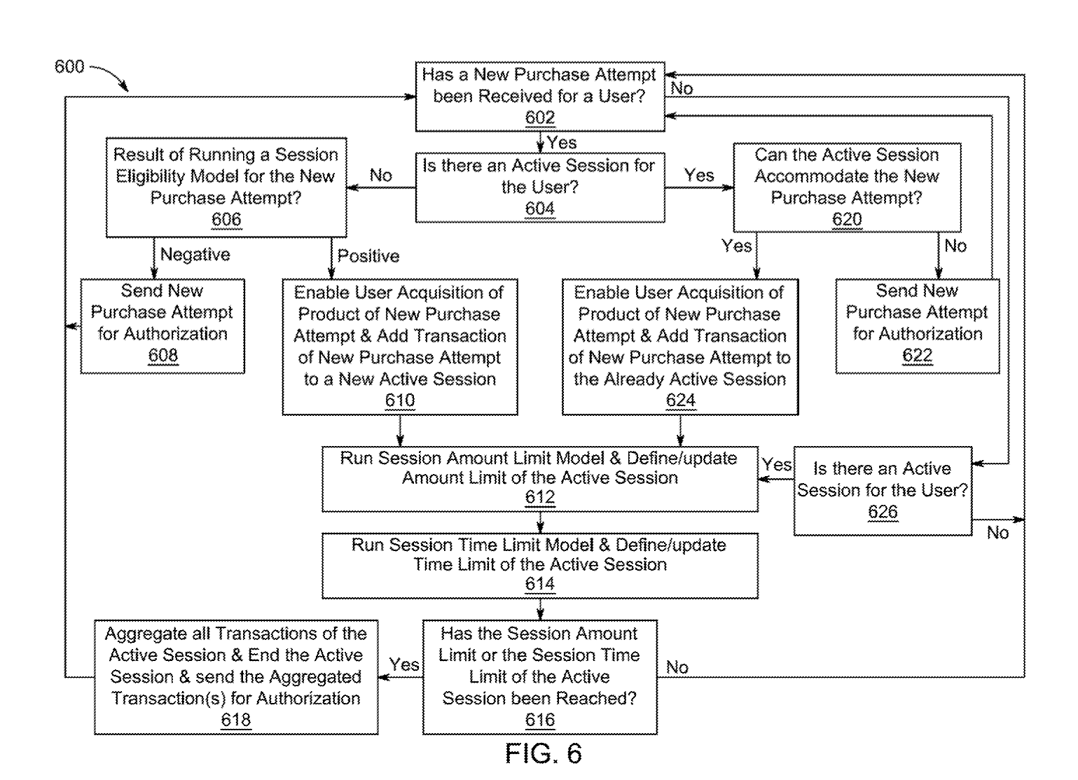

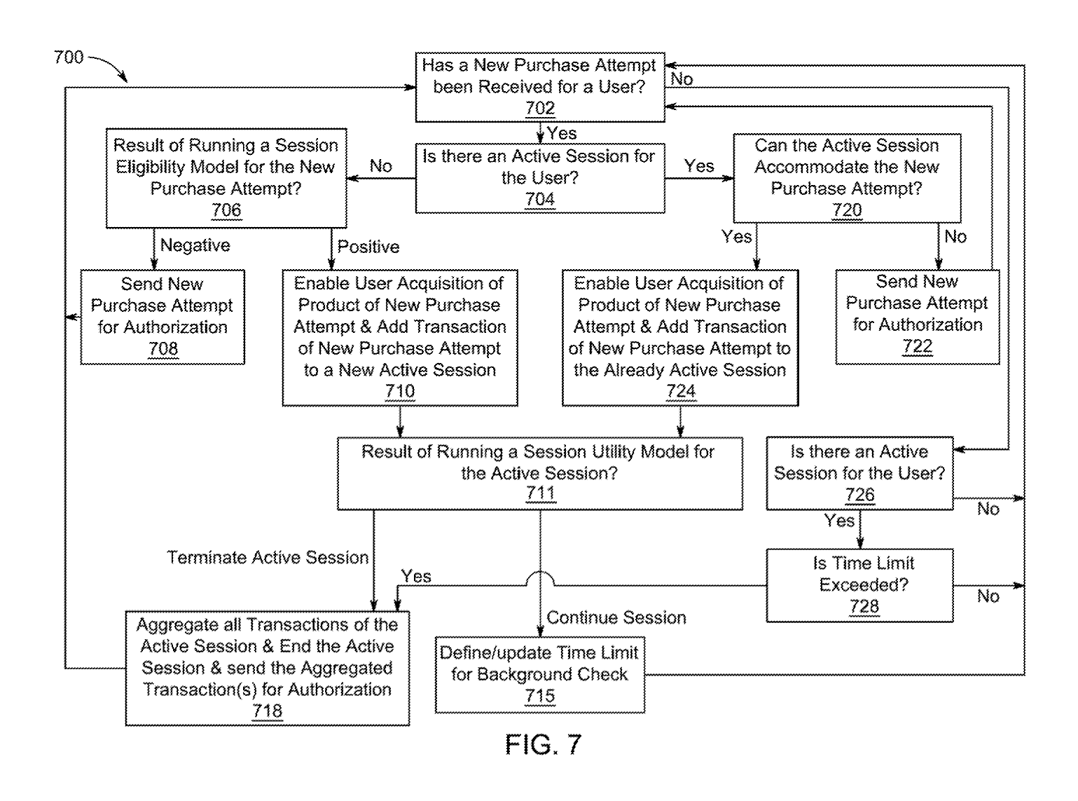

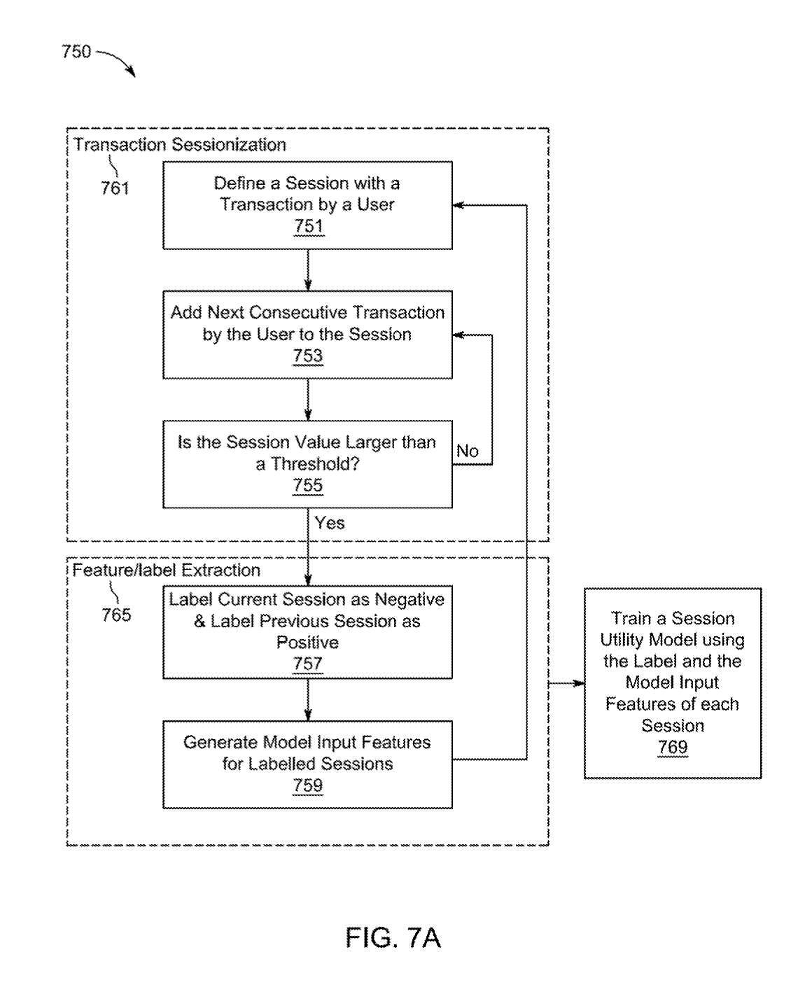

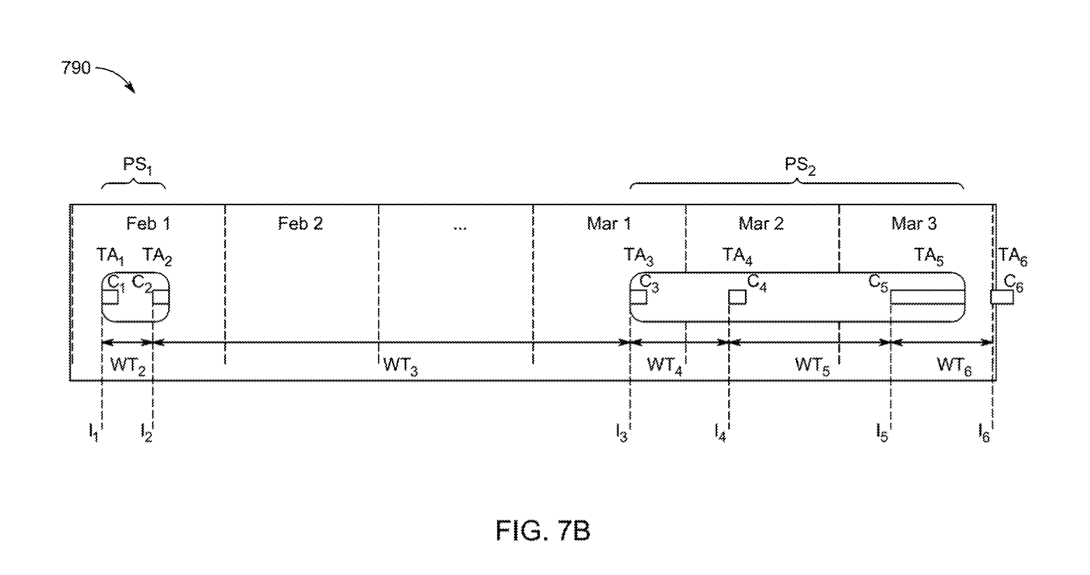

FIG. 1 shows a system 1 in which a payment session may be customized for aggregating one or more transactions between a service provider (“SP”) subsystem 200 and a user that may be using a user electronic device 100 and a transaction credential managed by a credential manager (“CM”) subsystem 300, while FIGS. 2 and 3 show further details with respect to particular embodiments of electronic device 100 of system 1, FIGS. 4 and 5 show further details with respect to particular embodiments of SP subsystem 200 of system 1, FIGS. 6 and 7 are flowcharts of illustrative processes for customizing payment sessions, FIG. 7A is a flowchart of an illustrative process for determining training data for a session utility model, and FIG. 7B is a timeline of exemplary historical transaction data that may be used for determining training data for a session utility model.

### Description of FIG. 1

FIG. 1 is a schematic view of an illustrative system 1 that may allow for customization of a payment session during which service transactions conducted between SP subsystem 200 and a customer (e.g., a user of electronic device 100) using a customer transaction credential managed by CM subsystem 300 may be aggregated. When SP subsystem 200 may facilitate aggregation of one or more service transactions conducted in a payment session with one or more customers (e.g., for one or more goods or services of the SP (e.g., SP product)) using a customer transaction credential (e.g., credit card credential, debit card credential, loyalty card credential, stored value credential, etc.) that may be managed by CM subsystem 300 (e.g., a financial institution subsystem) into an aggregated service transaction, SP subsystem 200 may communicate to CM subsystem 300 an aggregated transaction authorization request with any suitable SP authorization request data that may be indicative of the aggregated service transaction once the payment session has ended. Such SP authorization request data may include data indicative of the customer transaction credential as well as data indicative of the total amount of funds required from a funding account associated with the customer transaction credential (e.g., an account managed by CM subsystem 300 on behalf of the customer(s)) in order to fund the service transaction(s) of the aggregated service transaction as well as any suitable additional transaction information indicative of the transaction(s), such as a limited transaction descriptor that may be indicative of the identity of SP subsystem 200, and/or of the goods or services purchased, and/or the like. CM subsystem 300 may use such SP authorization request data to determine whether or not to approve or decline the transfer of funds from the funding account associated with the customer transaction credential to an account associated with SP subsystem 200 (e.g., to fund the service transaction(s) of the aggregated service transaction for the payment session on behalf of the customer).

However, during an active payment session, prior to SP subsystem 200 sending an aggregated transaction authorization request to CM subsystem 300 at the end of the payment session for obtaining funding for each service transaction conducted during the payment session, SP subsystem 200 may provide to the customer the applicable SP product being purchased for any service transaction conducted during the pendency of the active payment session, thereby essentially providing a loan to the customer prior to SP subsystem 200 actually requesting and/or receiving authorization from CM subsystem 300 to obtain the necessary funds for covering that SP product. Such a loan associated with a payment session comes with certain risk of customer delinquency or inability to fund the loan, while also providing certain benefits to SP subsystem 200 (e.g., reducing the number of transaction authorization requests that SP subsystem 200 must send to CM subsystem 300) and/or while also providing certain benefits to the customer (e.g., providing SP product to the customer more quickly after a customer's purchase attempt for a service transaction (e.g., without any delay due to SP subsystem 200 requesting and/or receiving authorization from CM subsystem 300 for the service transaction)). Therefore, a goal may be to customize the eligibility, time limit, value amount limit, and/or idle time of a payment session afforded by the SP subsystem to a customer for reducing the risk associated with the loan(s) of the payment session while also increasing the number and/or pendency of the payment sessions provided by the SP subsystem.

Various types of data may be used to customize the availability of a payment session to a customer and/or the time limit of a payment session made available to an eligible customer and/or the value amount limit of a payment session made available to an eligible customer or the viability or utility in continuing an active payment session. At least one suitable payment session model, such as any suitable machine learning model (e.g., a binary classification model, a multi-class classification model, a regression model, a random forest model, a gradient boosted tree model, an ensemble model, a neural network (e.g., a deep or wide or deep and wide neural network), a learning engine, models that are non-machine learning models or non-statistical learning based models, where such engines may include policy- or operations-based rules, third party learning APIs, etc., and/or the like), may be trained and utilized in conjunction with any suitable transaction data for customizing a payment session to be utilized by SP subsystem 200. For example, as described with respect to FIGS. 4-7B, any suitable payment session model may be trained in conjunction with any suitable number of sets of any suitable transaction data that may be indicative of any suitable features or categories or characteristics of one or more previous transactions by any customers (e.g., a successful or fraudulent individual transaction and/or a successful or fraudulent aggregated transaction of a payment session), and the eventual success or failure of the funding of the transaction of the set may be used as the truth (e.g., ground truth) for the training set, where such transaction data may be indicative of any suitable characteristics, features, or categories of the transaction(s), including, but not limited to, time limit of payment session, value amount limit of payment session, actual length of payment session, actual value amount of payment session, value amount of transaction purchase, SP product, type of SP product (e.g., sale or subscription or stream, etc.), genre of SP product (e.g., if product is a song, what genre of song), SP store used for transaction (e.g., an application store, a movie media store, a song/audiobook media store, an electronic device store, etc.), currency, type of customer transaction credential used (e.g., credit or debit or stored value, etc.), user identifier of customer purchaser, day of week of purchase, date of purchase, time of purchase, location of customer at time of purchase (e.g., city, state, country), age of purchaser, family status of purchase (e.g., whether customer's account with SP is a family account or an individual account), time since customer's previous purchase, number of customer's purchases having an open status over a particular period of time, number of customer's purchases having a closed status over a particular period of time, any suitable frequency based characteristics (e.g., number of purchases attempted or authorized for customer during a recent particular period of time (e.g., over the last 7 days)), any suitable value amount based characteristics (e.g., amount of last purchase made by customer or amount of all purchases attempted or authorized for customer during a recent particular period of time (e.g., over the last 7 days)), any suitable time based characteristics (e.g., day over day increased amount of attempted purchases or day over day increased amount of value of attempted purchases by customer), any suitable session based characteristics (e.g., a time length limit and/or value amount limit of payment session associated with transaction(s)), any suitable user behavior based characteristics (e.g., number of stores at which customer attempted purchase and/or number of sessions activated for customer during a recent particular period of time (e.g., over the last 7 days)), any suitable graph based characteristics, and/or the like. Then, such a payment session model may be used to predict or otherwise determine an appropriate availability and/or time limit and/or value amount limit of a payment session for a particular customer with respect to one or more particular attempted transaction purchases using any suitable available transaction data associated with such particular attempted transaction purchase(s) of the particular customer.

Different payment session models may be trained and/or utilized for determining different aspects of a payment session to be customized for a particular customer with respect to one or more particular attempted transaction purchases. For example, at least one payment session model (e.g., a session eligibility model (e.g., a binary classification model)) may be developed for use in determining (e.g., at operation 606 of process 600 of FIG. 6 or at operation 706 of process 700 of FIG. 7) whether or not a payment session ought to be made available to a particular customer in response to that customer making a particular purchase attempt while no payment session is currently active for that customer. As another example, at least one payment session model (e.g., a session amount limit model (e.g., a multi-class classification model or a regression model)) may be developed for use in determining (e.g., at operation 612 of process 600 of FIG. 6) a particular value amount limit (e.g., a discrete class or continuous numerical value) that ought to be used to at least partially define and/or update a payment session made available to a particular customer making a particular purchase attempt (e.g., that may set the maximum combined value amount of all purchase transactions to be aggregated during the payment session). As yet another example, at least one payment session model (e.g., a session time limit model (e.g., a multi-class classification model or a regression model)) may be developed for use in determining (e.g., at operation 614 of process 600 of FIG. 6) a particular time limit (e.g., a discrete class or continuous numerical value) that ought to be used to at least partially define and/or update a payment session made available to a particular customer making a particular purchase attempt (e.g., that may set the maximum duration of time during which the payment session may be active for enabling purchase transactions to be aggregated). As yet another example, at least one payment session model (e.g., a session utility model (e.g., a model trained via any suitable supervised approach (e.g., logistic regression, random forest, gradient boosted decision trees, deep learning (e.g., long short term memory (“LS™”))))) may be developed (e.g., at a process 750 of FIG. 7A) for use in determining (e.g., at operation 711 of process 700 of FIG. 7) a particular probability (e.g., a discrete class or continuous numerical value) that ought to be used to at least partially determine whether or not a current active payment session ought to be kept opened or closed (e.g., that may determine whether a session idle time may be minimized by closing or keeping open an active payment session). Therefore, a payment session time limit and/or a payment session value amount limit and/or a session utility probability may be identified using one or more payment session models based on particular transaction data associated with a particular customer and a particular transaction purchase attempt, such that a payment session may be personalized to a particular customer and/or different types of payment sessions may be afforded to different customers and/or different payment sessions may be afforded to a particular customer over time based on that particular customer's behavior.

In some embodiments, certain characteristics of a payment session may be dynamically changed during the pendency of that payment session based on new real-time data that may be made available to the system. For example, a payment session may be provided with a dynamic time limit for a background check or with a dynamic session time limit and/or a dynamic payment session value amount limit by re-training and/or re-inferring any suitable payment session model during the payment session using any new data that may be made available to the system during that session. As just one example, while a payment session with a particular time limit and a particular value amount limit may be active for a particular customer (e.g., as may have been determined by one or more payment session models at a first moment in time using first transaction data for the particular customer), the particular customer may attempt to make a new purchase, where such a new purchase may provide new transaction data that may be used by the system for potentially dynamically updating one or more characteristics of the active payment session (e.g., new SP product information, new purchase amount information, new SP store information, new time since last attempted purchase information, and/or the like may be provided as new second transaction data for the particular customer that may be provided as new input data into one or more payment session models for potentially defining a new particular time limit and/or a new particular value amount limit that may be used to dynamically update such characteristic(s) of the active payment session at a second moment in time (i.e., after such characteristic(s) may have been previously defined at the first moment in time)). The use of one or more payment session models may enable such dynamic updating of one or more characteristics of an active payment session that may be of a limited duration. Such models (e.g., neural networks) running on any suitable processing units (e.g., graphical processing units (“GPUs”) that may be available to SP subsystem 200) provide significant speed improvements in efficiency and accuracy with respect to prediction over other types of algorithms and human-conducted analysis of data, as such models can provide estimates in a few milliseconds or less, thereby improving the functionality of any computing device on which they may be run. Due to such efficiency and accuracy, such models enable a technical solution for enabling in-session dynamic updating of session characteristics (e.g., amount limit and/or time limit) using any suitable real-time data (e.g., data made available to the models during the session) that may not be possible without the use of such models, as such models may increase performance of their computing device(s) by requiring less memory, providing faster response times, and/or increased accuracy and/or reliability. Due to the condensed time frame of an active session and/or the time within which a decision with respect to a characteristic of a payment session ought to be made to provide a desirable customer experience, such models offer the unique ability to provide accurate determinations with the speed necessary to enable dynamic adjustments to an active payment session. Such models enable a data-driven model for customizing a payment session as opposed to a pre-defined payment session, a dynamically refreshable active payment session as opposed to a static payment session, and/or a utility probability based payment session as opposed to a rule-based payment session.

CM subsystem 300 may be provided by any suitable credential manager that may manage any funding account on behalf of a customer and/or that may provide a customer with any suitable customer transaction credential that may be used to identify to a service provider an associated funding account from which funds may be transferred to an account of the service provider in exchange for any suitable goods and/or services of the service provider. CM subsystem 300 may include a payment network subsystem (e.g., a payment card association or a credit card association) and/or an issuing bank subsystem and/or any other suitable type of subsystem. A specific customer transaction credential that may be used during a service transaction with SP subsystem 200 may be associated with a specific funding account of a particular user with CM subsystem 300 (e.g., accounts for various types of payment cards may include credit cards, debit cards, charge cards, stored-value cards (e.g., transit cards), fleet cards, gift cards, and the like). Such a customer transaction credential may be provisioned on device 100 (e.g., as CM credential information of an applet on a secure credential component (e.g., NFC component, secure element, and/or the like) of device 100) by CM subsystem 300 and may later be used by device 100 as at least a portion of a service transaction order communicated to SP subsystem 200 for funding a transaction between a customer and SP subsystem 200 (e.g., to pay for a good or service of the SP of SP subsystem 200). Alternatively, such a customer transaction credential may be provided to a customer as a physical credential card or any suitable credential information that may be relayed by the customer to an SP (e.g., over the telephone or via manual entry into a web form), which may be used by the SP for funding a service transaction.

SP subsystem 200 may be provided by any suitable service provider that may utilize customer transaction credential data to facilitate a service transaction for providing any suitable goods and/or services to a customer or another entity or device of the customer's choosing. As just one example, SP subsystem 200 may be provided by Apple Inc. of Cupertino, Calif., which may be a provider of various services to users of device 100 (e.g., the iTunes™ Store for selling/renting media to be played by device 100, the Apple App Store™ for selling/renting applications for use on device 100, the Apple iCloud™ Service for storing data from device 100 and/or associating multiple user devices and/or multiple user profiles with one another, the Apple Online Store for buying various Apple products online, etc.), and which may also be a provider, manufacturer, and/or developer of device 100 itself (e.g., when device 100 is an iPod™, iPad™, iPhone™, or the like) and/or of an operating system (e.g., device application 103) of device 100. As another example, SP subsystem 200 may be provided by a restaurant or a movie theater or an airline or a car dealership or any other suitable SP entity. The SP that may provide SP subsystem 200 (e.g., Apple Inc.) may be distinct and independent from any CM of any remote CM subsystem 300 (e.g., any funding entity of any remote funding subsystem, any financial institution entity of any remote financial institution subsystem, etc.). For example, the SP that may provide SP subsystem 200 may be distinct and/or independent from any payment network or issuing bank that may furnish and/or manage any credit card or any other customer transaction credential and/or customer payment credential and/or customer funding credential to be used by a customer for funding a service transaction with SP subsystem 200.

Communication of any suitable data between electronic device 100 and CM subsystem 300 may be enabled via any suitable communications set-up 95, which may include any suitable wired communications path, wireless communications path, or combination of two or more wired and/or wireless communications paths using any suitable communications protocol(s) and/or any suitable network and/or cloud architecture(s). Additionally or alternatively, communication of any suitable data between SP subsystem 200 and CM subsystem 300 may be enabled via any suitable communications set-up 95. Additionally or alternatively, communication of any suitable data between electronic device 100 and SP subsystem 200 that may not be made via CM subsystem 300 may be enabled via any suitable communications set-up 95. Communications set-up 95 may be at least partially managed by one or more trusted service managers (“TSMs”). Any suitable circuitry, device, system, or combination of these (e.g., a wired and/or wireless communications infrastructure that may include one or more communications towers, telecommunications servers, or the like) that may be operative to create a communications network may be used to provide at least a portion of communications set-up 95, which may be capable of providing communications using any suitable wired or wireless communications protocol. For example, communications set-up 95 may support Wi-Fi (e.g., an 802.11 protocol), ZigBee (e.g., an 802.15.4 protocol), WiDi™, Ethernet, Bluetooth™, BLE, high frequency systems (e.g., 900 MHz, 2.4 GHz, and 5.6 GHz communication systems), infrared, TCP/IP, SCTP, DHCP, HTTP, BitTorrent™, FTP, RTP, RTSP, RTCP, RAOP, RDTP, UDP, SSH, WDS-bridging, any communications protocol that may be used by wireless and cellular telephones and personal e-mail devices (e.g., GSM, GSM plus EDGE, CDMA, OFDMA, HSPA, multi-band, etc.), any communications protocol that may be used by a low power Wireless Personal Area Network (“6LoWPAN”) module, any other communications protocol, or any combination thereof.

### Description of FIG. 2

As shown in FIG. 2, for example, electronic device 100 may be any suitable electronic device that may interface with SP subsystem 200 in any suitable manner, such as via any suitable online resource, for enabling a customer user to attempt a new purchase for a service transaction with the SP and/or that may interface with CM subsystem 300 in any suitable manner, such as via any suitable online resource, for enabling a customer user to review previous transactions made with a transaction credential of the CM. For example, electronic device 100 may include, but is not limited to, a media player (e.g., an iPod™ available by Apple Inc. of Cupertino, Calif.), video player, still image player, game player, other media player, music recorder, movie or video camera or recorder, still camera, other media recorder, radio, medical equipment, domestic appliance, transportation vehicle instrument, musical instrument, calculator, cellular telephone (e.g., an iPhone™ available by Apple Inc.), other wireless communication device, personal digital assistant, remote control, pager, computer (e.g., a desktop, laptop, tablet (e.g., an iPad™ available by Apple Inc.), server, etc.), monitor, television, stereo equipment, set up box, set-top box, boom box, modem, router, printer, watch, biometric monitor, or any combination thereof. In some embodiments, electronic device 100 may perform a single function (e.g., a device dedicated to interfacing with remote subsystems via online resources) and, in other embodiments, electronic device 100 may perform multiple functions (e.g., a device that interfaces with remote subsystems via online resources and that manages a media library, plays music, and receives and transmits telephone calls). Electronic device 100 may be any portable, mobile, hand-held, or miniature electronic device that may be configured to interface with SP subsystem 200 and/or CM subsystem 300 wherever a user travels. Some miniature electronic devices may have a form factor that is smaller than that of hand-held electronic devices, such as an iPod™. Illustrative miniature electronic devices can be integrated into various objects that may include, but are not limited to, watches (e.g., an Apple Watch™ available by Apple Inc.), rings, necklaces, belts, accessories for belts, headsets, accessories for shoes, virtual reality devices, glasses, other wearable electronics, accessories for sporting equipment, accessories for fitness equipment, key chains, or any combination thereof. Alternatively, electronic device 100 may not be portable at all, but may instead be generally stationary.

As shown in FIG. 2, for example, electronic device 100 may include processing circuitry 102, memory 104, power supply circuitry 106, input component circuitry 108, output component circuitry 110, sensor circuitry 112, and communications circuitry 114. Electronic device 100 may also include a bus 115 that may provide one or more wired or wireless communication links or paths for transferring data and/or power to, from, or between various other components of device 100. In some embodiments, one or more components of electronic device 100 may be combined or omitted. Moreover, electronic device 100 may include any other suitable components not combined or included in FIG. 2 and/or several instances of the components shown in FIG. 2. For the sake of simplicity, only one of each of the components is shown in FIG. 2.

Memory 104 may include one or more storage mediums, including, for example, a hard-drive, flash memory, permanent memory such as read-only memory (“ROM”), semi-permanent memory such as random access memory (“RAM”), any other suitable type of storage component, or any combination thereof. Memory 104 may include cache memory, which may be one or more different types of memory used for temporarily storing data for electronic device applications. Memory 104 may be fixedly embedded within electronic device 100 or may be incorporated onto one or more suitable types of cards that may be repeatedly inserted into and removed from electronic device 100 (e.g., a subscriber identity module (“SIM”) card or secure digital (“SD”) memory card). Memory 104 may store media data (e.g., music and image files), software (e.g., for implementing functions on device 100), firmware, media information (e.g., media content and/or associated metadata), preference information (e.g., media playback preferences), lifestyle information (e.g., food preferences), exercise information (e.g., information obtained by exercise monitoring equipment or any suitable sensor circuitry), transaction information (e.g., information such as credit card information or other transaction credential information), wireless connection information (e.g., information that may enable device 100 to establish a wireless connection), subscription information (e.g., information that keeps track of podcasts or television shows or other media a user subscribes to), contact information (e.g., telephone numbers and e-mail addresses), calendar information, pass information (e.g., transportation boarding passes, event tickets, coupons, store cards or other transaction credentials (e.g., financial payment cards), etc.), any suitable payment session model data of device 100 (e.g., as may be stored in any suitable device payment session model 105 of memory assembly 104 (e.g., any portion or all of one, some, or each payment session model of SP subsystem 200 or otherwise as may be described herein)), any other suitable data, or any combination thereof.

Power supply circuitry 106 can include any suitable circuitry for receiving and/or generating power, and for providing such power to one or more of the other components of electronic device 100. For example, power supply circuitry 106 can be coupled to a power grid (e.g., when device 100 is not acting as a portable device or when a battery of the device is being charged at an electrical outlet with power generated by an electrical power plant). As another example, power supply circuitry 106 can be configured to generate power from a natural source (e.g., solar power using solar cells). As another example, power supply circuitry 106 can include one or more batteries for providing power (e.g., when device 100 is acting as a portable device). For example, power supply circuitry 106 can include one or more of a battery (e.g., a gel, nickel metal hydride, nickel cadmium, nickel hydrogen, lead acid, or lithium-ion battery), an uninterruptible or continuous power supply (“UPS” or “CPS”), and circuitry for processing power received from a power generation source (e.g., power generated by an electrical power plant and delivered to the user via an electrical socket or otherwise).

One or more input components 108 may be provided to permit a user to interact or interface with device 100. For example, input component circuitry 108 can take a variety of forms, including, but not limited to, a touch pad, dial, click wheel, scroll wheel, touch screen, one or more buttons (e.g., a keyboard), mouse, joy stick, track ball, microphone, still image camera, video camera, scanner (e.g., a bar code scanner or any other suitable scanner that may obtain product identifying information from a code, such as a bar code, or the like), proximity sensor, light detector, biometric sensor (e.g., a fingerprint reader or other feature recognition sensor, which may operate in conjunction with a feature-processing application that may be accessible to electronic device 100 for authenticating a user), line-in connector for data and/or power, and combinations thereof. Each input component 108 can be configured to provide one or more dedicated control functions for making selections or issuing commands associated with operating device 100.

Electronic device 100 may also include one or more output components 110 that may present information (e.g., graphical, audible, and/or tactile information) to a user of device 100. For example, output component circuitry 110 of electronic device 100 may take various forms, including, but not limited to, audio speakers, headphones, line-out connectors for data and/or power, visual displays, infrared ports, tactile/haptic outputs (e.g., rumblers, vibrators, etc.), and combinations thereof. As a particular example, electronic device 100 may include a display output component as output component 110, where such a display output component may include any suitable type of display or interface for presenting visual data to a user. A display output component may include a display embedded in device 100 or coupled to device 100 (e.g., a removable display). A display output component may include display driver circuitry, circuitry for driving display drivers, or both, and such a display output component can be operative to display content (e.g., media playback information, application screens for applications implemented on electronic device 100, information regarding ongoing communications operations, information regarding incoming communications requests, device operation screens, etc.) that may be under the direction of processor 102.

It should be noted that one or more input components and one or more output components may sometimes be referred to collectively herein as an input/output (“I/O”) component or I/O circuitry or I/O interface (e.g., input component 108 and output component 110 as I/O component or I/O interface 109). For example, input component 108 and output component 110 may sometimes be a single I/O component 109, such as a touch screen, that may receive input information through a user's touch (e.g., multi-touch) of a display screen and that may also provide visual information to a user via that same display screen.

Sensor circuitry 112 may include any suitable sensor or any suitable combination of sensors operative to detect movements of electronic device 100 and/or any other characteristics of device 100 or its environment (e.g., physical activity or other characteristics of a user of device 100). For example, sensor circuitry 112 may include any suitable sensor(s), including, but not limited to, one or more of a GPS sensor, accelerometer, directional sensor (e.g., compass), gyroscope, motion sensor, pedometer, passive infrared sensor, ultrasonic sensor, microwave sensor, a tomographic motion detector, a camera, a biometric sensor, a light sensor, a timer, or the like. In some examples, a biometric sensor may include, but is not limited to, one or more health-related optical sensors, capacitive sensors, thermal sensors, electric field (“eField”) sensors, and/or ultrasound sensors, such as photoplethysmogram (“PPG”) sensors, electrocardiography (“ECG”) sensors, galvanic skin response (“GSR”) sensors, posture sensors, stress sensors, photoplethysmogram sensors, and/or the like. While specific examples are provided, it should be appreciated that other sensors can be used and other combinations of sensors can be combined into a single device. In some examples, a GPS sensor or any other suitable location detection component(s) of device 100 can be used to determine a user's location and movement, as well as a displacement of the user's motion.

Communications circuitry 114 may be provided to allow device 100 to communicate with one or more other electronic devices or servers using any suitable communications protocol (e.g., with CM subsystem 300 and/or with SP subsystem 200 using communications set-up 95). For example, communications circuitry 114 may support Wi-Fi™ (e.g., an 802.11 protocol), ZigBee™ (e.g., an 802.15.4 protocol), WiDi™, Ethernet, Bluetooth™, Bluetooth™ Low Energy (“BLE”), high frequency systems (e.g., 900 MHz, 2.4 GHz, and 5.6 GHz communication systems), infrared, transmission control protocol/internet protocol (“TCP/IP”) (e.g., any of the protocols used in each of the TCP/IP layers), Stream Control Transmission Protocol (“SCTP”), Dynamic Host Configuration Protocol (“DHCP”), hypertext transfer protocol (“HTTP”), BitTorrent™, file transfer protocol (“FTP”), real-time transport protocol (“RTP”), real-time streaming protocol (“RTSP”), real-time control protocol (“RTCP”), Remote Audio Output Protocol (“RAOP”), Real Data Transport Protocol™ (“RDTP”), User Datagram Protocol (“UDP”), secure shell protocol (“SSH”), wireless distribution system (“WDS”) bridging, any communications protocol that may be used by wireless and cellular telephones and personal e-mail devices (e.g., Global System for Mobile Communications (“GSM”), GSM plus Enhanced Data rates for GSM Evolution (“EDGE”), Code Division Multiple Access (“CDMA”), Orthogonal Frequency-Division Multiple Access (“OFDMA”), high speed packet access (“HSPA”), multi-band, etc.), any communications protocol that may be used by a low power Wireless Personal Area Network (“6LoWPAN”) module, Near Field Communication (“NFC”), any other communications protocol, or any combination thereof. Communications circuitry 114 may also include or be electrically coupled to any suitable transceiver circuitry that can enable device 100 to be communicatively coupled to another device (e.g., a host computer or an accessory device) and communicate with that other device wirelessly, or via a wired connection (e.g., using a connector port). Communications circuitry 114 may be configured to determine a geographical position of electronic device 100. For example, communications circuitry 114 may utilize the global positioning system (“GPS”) or a regional or site-wide positioning system that may use cell tower positioning technology or Wi-Fi™ technology.

Processing circuitry 102 of electronic device 100 may include any processing circuitry that may be operative to control the operations and performance of one or more components of electronic device 100. For example, processor 102 may receive input signals from any input component 108 and/or sensor circuitry 112 and/or communications circuitry 114 and/or drive output signals through any output component 110 and/or communications circuitry 114. As shown in FIG. 2, processor 102 may be used to run at least one application 103. Application 103 may include, but is not limited to, one or more operating system applications, firmware applications, software applications, third party applications (e.g., applications managed by the SP of SP subsystem 200, the CM of CM subsystem 300, and/or the like), online resource applications, algorithmic modules, media analysis applications, media playback applications, media editing applications, communications applications, pass applications, calendar applications, social media applications, state determination applications, biometric feature-processing applications, activity monitoring applications, activity motivating applications, and/or any other suitable applications. For example, processor 102 may load application 103 as a user interface program to determine how instructions or data received via an input component 108 and/or any other component of device 100 may manipulate the one or more ways in which information may be stored and/or provided to the user via an output component 110 and/or any other component of device 100. Any application 103 may be accessed by any processing circuitry 102 from any suitable source, such as from memory 104 (e.g., via bus 115) and/or from another device or server (e.g., from CM subsystem 300 and/or from SP subsystem 200 (e.g., via an active internet connection (e.g., via communications circuitry 114))). For example, application 103 may be any suitable internet browsing application (e.g., for interacting with a website provided by CM subsystem 300 and/or by SP subsystem 200 for enabling device 100 to interact with an online service of CM subsystem 300 and/or SP subsystem 200), any suitable CM application (e.g., a web application or a native application that may be at least partially produced by CM subsystem 300 for enabling device 100 to interact with an online service of CM subsystem 300), any suitable SP application (e.g., a web application or a native application that may be at least partially produced by SP subsystem 200 for enabling device 100 to interact with an online service of SP subsystem 200), or any other suitable applications. As one example, an application 103 may provide a user with the ability to interact with a service or platform of CM subsystem 300, where such an application 103 may be a third party application that may be running on device 100 (e.g., an application associated with CM subsystem 300 that may be loaded on device 100 from CM subsystem 300 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by CM subsystem 300 (e.g., running on a server of CM subsystem 300) or any other remote subsystem). Therefore, application 103 may be configured to provide a CM online resource, such as a website or native online application, for presentation of a CM interface to a user on device 100. As another example, an application 103 may provide a user with the ability to interact with a service or platform of SP subsystem 200, where such an application 103 may be a third party application that may be running on device 100 (e.g., an application associated with SP subsystem 200 that may be loaded on device 100 from SP subsystem 200 or via an application market (e.g., from SP subsystem 200 if a media market SP) and/or that may be accessed via an internet application or web browser running on device 100 (e.g., processor 112) that may be pointed to a uniform resource locator (“URL”) whose target or web resource may be managed by SP subsystem 200 (e.g., running on a server of SP subsystem 200) or any other remote subsystem). Therefore, application 103 may be configured to provide an SP online resource, such as a website or native online application, for presentation of a SP interface to a user on device 100. In a particular example, as shown in FIG. 2, processor 102 may be used to run a first application 103 that may be an operating system application and a second application 103a that may be a third party application or any other suitable online resource (e.g., an application associated with a service provider of SP subsystem 200 (e.g., a media store, an app store, etc.) or an application associated with a credential manager of CM subsystem 300 (e.g., credential manager app, etc.)). Moreover, processor 102 may have access to device identification information 119, which may be utilized to provide identification of device 100 (e.g., identification of the particular device 100 and/or identification of the type of device 100 (e.g., make and/or model and/or the like) to a remote subsystem (e.g., a unique device identification to SP subsystem 200 and/or to CM subsystem 300)). Processor 102 may include a single processor or multiple processors. For example, processor 102 may include at least one “general purpose” microprocessor, a combination of general and special purpose microprocessors, instruction set processors, graphics processors, video processors, communications processors, motion processors, biometric processors, application processors, and/or related chips sets, and/or special purpose microprocessors. Processor 102 also may include on board memory for caching purposes.

Although not shown, device 100 may include any suitable secure credential component (e.g., NFC component, secure element, and/or the like) that may include or otherwise be configured to provide a tamper-resistant platform (e.g., as a single-chip or multiple-chip secure microcontroller) that may be capable of securely hosting applications and their confidential and cryptographic data in accordance with rules and security requirements that may be set forth by a set of well-identified trusted authorities (e.g., an authority of SP subsystem 200 and/or of CM subsystem 300 and/or of an industry standard, such as GlobalPlatform). Any suitable customer transaction credential information, such as CM credential information, may be stored in an applet on such a secure credential component of device 100 and may be configured to provide customer transaction credential data for use in any suitable service transaction order with a remote entity subsystem, such as SP subsystem 200. For example, the customer transaction credential data may provide an actual value source and/or may provide sufficient detail for identifying a funding account of CM subsystem 300 that may be used to as a value source, and the value source may be used to at least partially fund a service transaction between electronic device 100 and SP subsystem 200 for any suitable service provider service (e.g., any suitable good or service that may be provided on behalf of SP subsystem 200 for the benefit of a user of electronic device 100).

Electronic device 100 may also be provided with a housing 101 that may at least partially enclose one or more of the components of device 100 for protection from debris and other degrading forces external to device 100. In some embodiments, one or more of the components may be provided within its own housing (e.g., input component 108 may be an independent keyboard or mouse within its own housing that may wirelessly or through a wire communicate with processor 102, which may be provided within its own housing).

Although not shown, SP subsystem 200 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

Although not shown, CM subsystem 300 may also include a processor component that may be the same as or similar to processor component 102 of electronic device 100, a communications component that may be the same as or similar to communications component 114 of electronic device 100, an I/O interface that may be the same as or similar to I/O interface 109 of electronic device 100, a bus that may be the same as or similar to bus 115 of electronic device 100, a memory component that may be the same as or similar to memory 104 of electronic device 100, and/or a power supply component that may be the same as or similar to power supply 106 of electronic device 100.

### Description of FIG. 3

As shown in FIG. 3, one specific example of electronic device 100 may be an electronic device, such as an iPhone™, where housing 101 may allow access to various input components 108a-108i, various output components 110a-110c, and various I/O components 109a-109c through which device 100 and a user and/or an ambient environment may interface with each other. Input component 108a may include a button that, when pressed, may cause a “home” screen or menu of a currently running application to be displayed by device 100. Input component 108b may be a button for toggling electronic device 100 between a sleep mode and a wake mode or between any other suitable modes. Input component 108c may include a two-position slider that may disable one or more output components 112 in certain modes of electronic device 100. Input components 108d and 108e may include buttons for increasing and decreasing the volume output or any other characteristic output of an output component 110 of electronic device 100. Each one of input components 108a-108e may be a mechanical input component, such as a button supported by a dome switch, a sliding switch, a control pad, a key, a knob, a scroll wheel, or any other suitable form.

An output component 110a may be a display that can be used to display a visual or graphic user interface (“GUI”) 180, which may allow a user to interact with electronic device 100. A screen 190 of GUI 180 may include various layers, windows, screens, templates, elements, menus, and/or other components of a currently running application (e.g., application 103) that may be displayed in all or some of the areas of display output component 110a. One or more of user input components 108a-108i may be used to navigate through GUI 180. For example, one user input component 108 may include a scroll wheel that may allow a user to select one or more graphical elements or icons 182 of GUI 180. Icons 182 may also be selected via a touch screen I/O component 109a that may include display output component 110a and an associated touch input component 108f. Such a touch screen I/O component 109a may employ any suitable type of touch screen input technology, such as, but not limited to, resistive, capacitive, infrared, surface acoustic wave, electromagnetic, or near field imaging. Furthermore, touch screen I/O component 109a may employ single point or multi-point (e.g., multi-touch) input sensing.

Icons 182 may represent various applications, layers, windows, screens, templates, elements, and/or other components that may be displayed in some or all of the areas of display component 110a upon selection by the user. Furthermore, selection of a specific icon 182 may lead to a hierarchical navigation process. For example, selection of a specific icon 182 may lead from screen 190 of FIG. 3 to a new screen of GUI 180 that may include one or more additional icons or other GUI elements of the same application or of a new application associated with that icon 182. Textual indicators 181 may be displayed on or near each icon 182 to facilitate user interpretation of each graphical element icon 182. It is to be appreciated that GUI 180 may include various components arranged in hierarchical and/or non-hierarchical structures. When a specific icon 182 is selected, device 100 may be configured to open a new application associated with that icon 182 and display a corresponding screen of GUI 180 associated with that application. As an example, when the specific icon labeled with a “Calendar” textual indicator is selected, device 100 may launch or otherwise access a specific calendar or reminder application and may display screens of a specific user interface that may include one or more tools or features for interacting with one or more events or other reminders that may be time-sensitive in a specific manner. As another example, when the specific icon labeled with a “Credential Manager” textual indicator is selected, device 100 may launch or otherwise access a specific CM application (e.g., CM online resource) and may display screens of a specific user interface that may include one or more tools or features for interacting with CM subsystem 300 in a specific manner. As another example, when the specific icon labeled with a “Wallet” textual indicator is selected, device 100 may launch or otherwise access a specific pass or wallet application and may display screens of a specific user interface that may include one or more tools or features for interacting with one or more passes or other credentials (e.g., payment credentials of an NFC and/or secure element component of device 100) in a specific manner. For each application, screens may be displayed on display output component 110a and may include various user interface elements. Additionally or alternatively, for each application, various other types of non-visual information may be provided to a user via various other output components 110 of device 100.

Electronic device 100 also may include various other I/O components 109 that may allow for communication between device 100 and other devices, such as a connection port 109b that may be configured for transmitting and receiving data files, such as media files or customer order files, and/or any suitable information (e.g., audio signals) from a remote data source and/or power from an external power source. For example, I/O component 109b may be any suitable port (e.g., a Lightning™ connector or a 30-pin dock connector available by Apple Inc.). I/O component 109c may be a connection slot for receiving a SIM card or any other type of removable component. Electronic device 100 may also include at least one audio input component 110g, such as a microphone, and at least one audio output component 110b, such as an audio speaker. Electronic device 100 may also include at least one tactile output component 110c (e.g., a rumbler, vibrator, haptic and/or taptic component, etc.), a camera and/or scanner input component 108h (e.g., a video or still camera, and/or a bar code scanner or any other suitable scanner that may obtain product identifying information from a code, such as a bar code, or the like), and a biometric input component 108i (e.g., a fingerprint reader or other feature recognition sensor, which may operate in conjunction with a feature-processing application that may be accessible to electronic device 100 for authenticating a user).

### Description of FIGS. 4 and 5

Referring now to FIG. 4, FIG. 4 shows further details with respect to particular embodiments of SP subsystem 200 of system 1. As shown in FIG. 4, SP subsystem 200 may be a secure platform system and may include a secure mobile platform (“SMP”) broker component 240, an SMP trusted services manager (“TSM”) component 250, an SMP crypto services component 260, an identity management system (“IDMS”) component 270, a fraud system component 280, a hardware security module (“HSM”) component 290, a store component 265, and/or one or more servers 210. One, some, or all components of SP subsystem 200 may be implemented using one or more processor components, which may be the same as or similar to processor circuitry 102 of device 100, one or more memory components, which may be the same as or similar to memory 104 of device 100, and/or one or more communications components, which may be the same as or similar to communications circuitry 114 of device 100. Any suitable communication protocol or combination of communication protocols may be used by SP subsystem 200 to communicate data amongst the various components of SP subsystem 200 (e.g., via at least one communications path 295 of FIG. 4) and/or to communicate data between SP subsystem 200 and other components of system 1 (e.g., CM subsystem 300 and/or electronic device 100). One, some, or all components of SP subsystem 200 may be managed by, owned by, at least partially controlled by, and/or otherwise provided by a single SP (e.g., Apple Inc.) that may be distinct and independent from any CM subsystem 300. The components of SP subsystem 200 may interact with each other and collectively with any suitable CM subsystem 300 and/or electronic device 100 for facilitating one or more service transactions and/or for training, inferring, managing, or otherwise using one or more payment session models for customizing the use of one or more payment sessions for one or more customers.

SMP broker component 240 of SP subsystem 200 may be configured to manage customer authentication with an SP customer account of SP subsystem 200 and/or to manage CM validation with a CM subsystem account of SP subsystem 200. SMP broker component 240 may be a primary end point that may control certain interface elements (e.g., elements of a GUI 180) on device 100. A CM application of CM subsystem 300 may be configured to call specific application programming interfaces (“APIs”) and SMP broker 240 may be configured to process requests of those APIs and respond with data that may derive a portion of a user interface that may be presented by CM subsystem 300 (e.g., to device 100) and/or respond with application protocol data units (“APDUs”) that may communicate with CM subsystem 300. Such APDUs may be received by SP subsystem 200 from CM subsystem 300 via a trusted services manager (“TSM”) of system 1 (e.g., a TSM of a communication path between SP subsystem 200 and CM subsystem 300). In some particular embodiments, SMP TSM component 250 of SP subsystem 200 may be configured to provide Global Platform-based services or any other suitable services that may be used to carry out credential provisioning operations on device 100 from CM subsystem 300. GlobalPlatform, or any other suitable secure channel protocol, may enable SMP TSM component 250 to properly communicate and/or provision sensitive account data between a secure element of device 100 and a TSM for secure data communication between SP subsystem 200 and a remote subsystem.

SMP TSM component 250 may be configured to use HSM component 290 to protect keys and generate new keys. SMP crypto services component 260 of SP subsystem 200 may be configured to provide key management and cryptography operations that may be provided for user authentication and/or confidential data transmission between various components of system 1 (e.g., between SP subsystem 200 and CM subsystem 300 and/or between SP subsystem 200 and device 100 and/or between different components of SP subsystem 200). SMP crypto services component 260 may utilize HSM component 290 for secure key storage and/or opaque cryptographic operations. A payment crypto service of SMP crypto services component 260 may be configured to interact with IDMS component 270 to retrieve information associated with on-file credit cards or other types of customer transaction credentials associated with user accounts of the SP (e.g., an Apple iCloud™ account). Such a payment crypto service may be configured to be the only component of SP subsystem 200 that may have clear text (e.g., non-hashed) information describing customer transaction credentials (e.g., credit card numbers) of its user accounts in memory. Fraud system component 280 of SP subsystem 200 may be configured to run an SP fraud check on a customer transaction credential based on data known to the SP about the transaction credential and/or the customer (e.g., based on data (e.g., customer transaction credential information) associated with a customer account with the SP and/or any other suitable data that may be under the control of the SP and/or any other suitable data that may not be under the control of a remote subsystem). Fraud system component 280 may be configured to determine an SP fraud score for the credential based on various factors or thresholds. Additionally or alternatively, SP subsystem 200 may include store 265, which may be a provider of various services to users of device 100 (e.g., the iTunes™ Store for selling/renting media to be played by device 100, the Apple App Store™ for selling/renting applications for use on device 100, the Apple iCloud™ Service for storing data from device 100 and/or associating multiple user devices and/or multiple user profiles with one another, the Apple Online Store for buying various Apple products online, the Apple Music™ Service for enabling subscriptions of various streaming services, etc.). As just one example, store 265 may be configured to manage and provide an application 103 and/or application 103a to device 100, where the application may be any suitable application, such as a CM application (e.g., a banking application), an SP application (e.g., a music streaming service application), an e-mail application, a text messaging application, an internet application, a credential management application, or any other suitable communication application, and/or to provide any suitable SP product to a customer (e.g., a media file to memory 104 of customer device 100, etc.).

Server 210 may be any suitable server that may be operative to handle any suitable services or functionalities of SP subsystem 200. In other embodiments, at least a portion or the entirety of server 210 may be an independent subsystem distinct from SP subsystem 200 (e.g., as a third party subsystem of a third party that may be distinct from the SP of SP subsystem 200 or as another subsystem provided by the SP of SP subsystem 200 that may be distinct from SP subsystem 200). As shown in FIG. 5, server 210 may be a payment session model management server that may be operative to train, infer, manage, or otherwise use one or more payment session models for customizing the use of one or more payment sessions for one or more customers of SP subsystem 200. For example, at least one payment session model, such as one or more payment session models 205, may be developed and/or generated for use in determining an appropriate payment session accessibility (e.g., payment session eligibility) for a particular customer and/or for use in determining an appropriate payment session characteristic (e.g., a payment session time limit and/or a payment session value amount limit) for an approved payment session for a particular customer (e.g., during initial activation of a payment session and/or at any other suitable moment(s) during the pendency of an active payment session (e.g., periodically and/or in response to a new purchase attempt being received for the particular customer)). For example, any or all transaction data 211 available to system 1 (e.g., data indicative of any or all characteristics of any or all transactions previously completed and/or attempted by SP subsystem 200 or otherwise for any customers or subset of customers (e.g., account history, purchase history, authorization history, and/or the like available to SP subsystem 200 and/or CM subsystem 300 and/or one or more customer devices 100 and/or any other suitable subsystems or data sources accessible by server 210)) may be collected at a data storage (e.g., file system and/or database) 212, and a feature generator 214 may be operative to selectively pull some or all such transaction data 211 from data storage 212 as batch job data 215 into a batch job data storage (e.g., file system and/or database) 216, where batch job data 215 may be all transaction data of data 211 that was generated within the last 30 days (e.g., transaction data associated with transactions initiated within the last 30 days) or any other suitable timeframe and/or all transaction data with any other suitable commonality. As shown, for example, data 211 and/or data 215 may include various feature transaction data, including, but not limited to, “buys_last_x_days” (e.g., number of purchases attempted within last X days by a particular customer associated with a particular transaction data set), “amt_last_x_days” (e.g., total value amount and/or transaction count of all transactions attempted within last X days by a particular customer associated with a particular transaction data set), “sess_last_x_days” (e.g., total number of payment sessions activated within last X days by a particular customer associated with a particular transaction data set), average total value amount per day of all transactions attempted over last X days by a particular customer associated with a particular transaction data set, average minimum value amount per day of all transactions attempted over last X days by a particular customer associated with a particular transaction data set, average maximum value amount per day of all transactions attempted over last X days by a particular customer associated with a particular transaction data set, average number of transactions per day attempted over last X days by a particular customer associated with a particular transaction data set, minimum interval between transactions attempted over last X days by a particular customer associated with a particular transaction data set, maximum interval between transactions attempted over last X days by a particular customer associated with a particular transaction data set, number of billing accounts used over last X days by a particular customer associated with a particular transaction data set, number of successful authorizations over last X days for a particular customer associated with a particular transaction data set, ratio of successful authorizations to all authorization requests over last X days for a particular customer associated with a particular transaction data set, number of in-app purchases (or any particular product or service type of purchase) over last X days by a particular customer associated with a particular transaction data set, list of genres of products or content types purchased over last X days by a particular customer associated with a particular transaction data set, “layers_to_fraudster” (e.g., closeness of customer to another user that has been identified as a fraudster (e.g., as may be determined by a user graph of users connected by one or more shared properties, such as social network relations, geographical distances, internet protocol similarities, SP products of interest/attempted to be purchased similarities, etc.), which may be indicative of a level of suspiciousness attributed to the customer), and/or the like. A model builder 218 may be operative to receive some or all of batch job data 215 from batch job database 216 (or some or all of data 211 from database 212 when generator 214 and/or database 216 may not be used) and to use such data to build (e.g., train) one or more payment session models 205 (e.g., one or more batch job payment session models 217), such as one or more regression models, boosted tree models, neural network models, and/or any other suitable types of models, one or more of which may be trained as a particular type of model (e.g., a payment session eligibility model, a payment session value amount limit model, a payment session time limit model, etc.).

Some or all models generated or otherwise trained or built by model builder 218 may be collected by a model repository 232, while a best model identifier 234 may be operative to identify the best performing model(s) of model repository 232 using any suitable techniques (e.g., model identifier 234 may identify a best performing model for each one of the various types of payment session models available to system 1 at a particular moment (e.g., a best performing payment session eligibility model, a best performing payment session value amount limit model, a best performing payment session time limit model, a best performing session utility model, etc.), each of which may be the same or different type of machine learning model). Then, when one or more particular types of payment session model is to be used to customize a payment session experience for a particular customer attempting a particular purchase transaction, a model request server 236 may be operative to receive from any suitable source (e.g., any suitable client source for server 210 (e.g., store 265)) a request 239 for such model(s) that may include model request data 239d (e.g., any suitable transaction data associated with a particular customer and/or a particular transaction of that customer, including, but not limited to, a “dsid” (e.g., a unique customer identifier for the particular customer and/or a customer score indicative of some trustworthiness or fraud score or otherwise that may be associated with the customer), a “store_front_id” (e.g., an identifier of the particular store that received the transaction purchase attempt from the customer (e.g., a particular app store, a particular music subscription service, etc.)), a “buy_amount” (e.g., a value amount of the SP product(s) to be purchased in the transaction purchase attempt), “buys_last_x_hours” (e.g., number of purchases attempted or authorized for the particular customer during the last X hours), “card_type” (e.g., type of transaction credential being used for the transaction purchase attempt), “flow_step” (e.g., relative operation within a payment session customization flow at which request 239 was generated (e.g., which of operations 606, 612, 614, and/or the like of process 600 of FIG. 6 initiated the request and from which other operation did process 600 arrive at that operation, etc. and/or which of operations 706, 711, 715, and/or the like of process 700 of FIG. 7 initiated the request and from which other operation did process 700 arrive at that operation, etc.)), and/or the like (e.g., any suitable type/feature of transaction data that may also be represented by data 211, 215, 221, 225, and/or the like)).

In response to receiving such a request 239, model request server 236 may be operative to use some or all of model request data 239d as input data to one or more of the payment session models available to model request server 236 (e.g., one or more of the best payment session models of best model identifier 234) in order to receive appropriate payment session model output data 205d (e.g., any suitable model output data that may be used to customize a payment session experience for the particular customer, including, but not limited to, a “delinquent_score” (e.g., a negative or positive payment session eligibility indicator for the particular customer as may be determined by a best performing payment session eligibility model available to model request server 236 using at least some transaction data of model request data 239d as model input data (e.g., as may be used by operation 606 of process 600 and/or as may be used by operation 706 of process 700)), a “session_len_cap” (e.g., any suitable length of time (e.g., as may be defined by one of multiple discrete classes of a multi-classification model or by any continuous numerical value of a regression model) that may be used to define a payment session value amount limit for a payment session to be afforded to the particular customer as may be determined by a best performing payment session value amount limit model available to model request server 236 using at least some transaction data of model request data 239d as model input data (e.g., as may be used by operation 612 of process 600)), a “session_amt_cap” (e.g., any suitable amount of any suitable currency (e.g., as may be defined by one of multiple discrete classes of a multi-classification model or by any continuous numerical value of a regression model) that may be used to define a payment session time limit for a payment session to be afforded to the particular customer as may be determined by a best performing payment session time limit model available to model request server 236 using at least some transaction data of model request data 239d as model input data (e.g., as may be used by operation 614 of process 600)), and/or the like).

Any or all of such payment session model output data 205d that may be received by model request server 236 for a particular request 239 may be provided as at least a portion of any suitable model response data 237d for a model response 237 that may be returned by server 210 to any suitable target (e.g., the client source (e.g., store 265) that may have provided request 239). As shown, in addition to any suitable model output data 205d, model response data 237d may include any suitable additional model response data that may help facilitate customization and/or use of a payment session for the particular customer, including, but not limited to, a “dsid” (e.g., the unique customer identifier for the particular customer and/or a customer score indicative of some trustworthiness or fraud score or otherwise that may be associated with the customer (e.g., the same identifier as in request 239, which may facilitate linking request 239 and response 237)), a “timestamp” (e.g., any suitable timestamp indicative of the time at which all or any suitable portion of response data 237d (e.g., “session_len_cap” of data 205d) may have been generated, which may enable a determination as to whether or not the session time limit for the payment session has expired (e.g., at operation 616 of process 600) by comparing a current time to the sum of the “timestamp” and the “session_len_cap” of data 237d), a “model_version” (e.g., any suitable data that may be indicative of a particular model of server 210 that may have been used to generate at least a portion of data 205d and/or of a type of such a model and/or the like, which may be used for diagnostic purposes or any other suitable purposes, where such optional data may be exposed to the client and may be useful, for example, when the client would like to determine how and/or when the model output evolved, where an A/B test or experiment or otherwise might be conducted based on such data by the client or otherwise), and/or the like.

As also shown in FIG. 5, server 210 may also include a streaming job set of databases and/or other modules that may be operative to identify certain features/inputs of at least one model that may be of particular significance or importance to the effectiveness of that model. For example, one or more payment session models 205 built by model builder 218 (e.g., one or more batch job payment session models 217) or otherwise available to server 210 may be analyzed in any suitable manner by a feature selector 220 to identify one or more features (e.g., inputs) that have a significant impact on the effectiveness of the model being analyzed (e.g., to determine the input(s) of the model that have the most effect on the output(s) of the model). Then those features of importance (e.g., each feature that reaches a particular importance threshold and/or each one of a particular number of features that are the most important to the model) identified by feature selector 220 for a particular model may be utilized by a streaming job feature generator 224. For example, streaming job feature generator 224 may be operative to selectively pull some or all transaction data 221 from a queue data storage 222 as shortlist or streaming job data 225 into a streaming job data storage (e.g., file system and/or database) 226, where streaming job data 225 may be only the transaction data of transaction data 221 indicative of the features identified by feature selector 220. For example, as shown, data 225 may include various feature transaction data, including, but not limited to, “buys_last_x_days” (e.g., number of purchases attempted within last X days by a particular customer associated with a particular transaction data set), “amt_last_x_days” (e.g., total value amount and/or transaction count of all transactions attempted within last X days by a particular customer associated with a particular transaction data set), “layers_to_fraudster”, and/or the like, but not “sess_last_x_days” (e.g., total number of payment sessions activated within last X days by a particular customer associated with a particular transaction data set), as may be provided by data 215. In some embodiments, data 221 may differ from data 211 in that data 221 may only be transaction data generated within a recent period of time (e.g., real-time or near real-time data that may be made accessible to server 210), such as transaction data generated within the last 5 minutes, or within the last 2 hours or any other suitable batch update refresh period that may otherwise collect new data 211. For example, data 211 and data 221 may differ in any one or more suitable ways, including, but not limited to, length of data processing history (e.g., data 211 may be an archived data processed in the past few days to years, while data 221 may be much more recent data), need for (near) real-time data (e.g., data 211 may have much longer latency than data 221), storage location/database (e.g., data 211 may be stored in a file system (e.g., distributed file system) or transaction database while data 221 may be stored in a queue platform with data low-latency, such as Apache Kafka), and/or the like. Then, a streaming job model builder 228 may be operative to receive some or all of the models built by batch job model builder 218 (e.g., one or more payment session models 205 (e.g., one or more batch job payment session models 217) via feature selector 220) as well as streaming job data 225 from streaming job database 226 (or some or all of data 221 from database 222 when generator 224 and/or database 226 may not be used) and to use such data to further build (e.g., re-train or further train or refresh) one or more the received payment session models 205 (e.g., one or more batch job payment session models 217) (e.g., as one or more updated or re-trained or refreshed streaming job payment session models 227), and each re-trained or updated model may be provided via model updater 230 to model repository 232.

Therefore, streaming job model builder 228 may be operative to update one or more batch job models using only particular feature types of transaction data 225 from data 221 of queue database 222, where such updating by builder 228 may be accomplished with limited overhead and/or limited processing in a more efficient manner (e.g., as only a limited set of features of a limited set of transaction data may be used to retrain one or more models). Thus, modules 220, 222, 224, 226, 228, and/or 230 may be operative to update and/or improve the training of one or more payment session models based on real-time or near-real time data in an efficient manner (e.g., by focusing on only certain features of transaction data that may be of significant importance to the effectiveness of the model(s) and/or by only using newly generated transaction data). This may enable a certain type of payment session model, such as a payment session value amount limit model and/or a payment session time limit model, to be re-trained or otherwise refreshed using transaction data generated or otherwise first made available to server 210 (e.g., via data 221) during an active payment session for which that refreshed model may then be used to make a determination on an updated characteristic (e.g., an updated value amount limit and/or an updated time limit) for that active payment session (e.g., at operation 612 and/or operation 614 of process 600 (e.g., following operation 624 and/or operation 626 of process 600 (e.g., periodically and/or in response to a new purchase attempt being received for the particular customer))).

Any suitable API(s) may be used between any two communicating entities of system 1. Store 265 may call an API endpoint with a request 239 to retrieve a response, and the API response to the call may be a response 237 from server 210. Additionally or alternatively, server 210 may call an API endpoint with a request for any suitable data 211 and/or data 332 from any suitable data source, and the API response to the call may be any suitable transaction data 211 and/or 221 or otherwise from any suitable data source.

Thus, one or more payment session models 205 managed by server 210 may be operative to effectively and efficiently determine an appropriate payment session eligibility and/or payment session amount limit and/or payment session time limit for a particular customer in a particular transaction situation. For example, such a payment session model or payment session learning engine may include any suitable neural network (e.g., an artificial neural network) that may be initially configured, trained on one or more sets of scored (e.g., authorized and/or fraudulent) transaction data for one or more past transactions (e.g., individual and/or aggregated transactions by any customers or particular customer(s)), and then used to predict an appropriate characteristic or eligibility of a customized payment session experience for a particular customer in a particular transaction situation.

A neural network or neuronal network or artificial neural network or any other suitable type of model for use in managing one or more payment session models may be hardware-based, software-based, or any combination thereof, such as any suitable model (e.g., an analytical model, a computational model, etc.), which, in some embodiments, may include one or more sets or matrices of weights (e.g., adaptive weights, which may be numerical parameters that may be tuned by one or more learning algorithms or training methods or other suitable processes) and/or may be capable of approximating one or more functions (e.g., non-linear functions or transfer functions) of its inputs. The weights may be connection strengths between neurons of the network, which may be activated during training and/or prediction. A neural network may generally be a system of interconnected neurons that can compute values from inputs and/or that may be capable of machine learning and/or pattern recognition (e.g., due to an adaptive nature). A neural network may use any suitable machine learning techniques to optimize a training process. The neural network may be used to estimate or approximate functions that can depend on a large number of inputs and that may be generally unknown. The neural network may generally be a system of interconnected “neurons” that may exchange messages between each other, where the connections may have numeric weights (e.g., initially configured with initial weight values) that can be tuned based on experience, making the neural network adaptive to inputs and capable of learning (e.g., learning pattern recognition). A suitable optimization or training process may be operative to modify a set of initially configured weights assigned to the output of one, some, or all neurons from the input(s) and/or hidden layer(s). A non-linear transfer function may be used to couple any two portions of any two layers of neurons, including an input layer, one or more hidden layers, and an output (e.g., an input to a hidden layer, a hidden layer to an output, etc.).

Different input neurons of the neural network may be associated with respective different types of features or categories of transaction data and may be activated by transaction feature data of the respective transaction feature (e.g., each possible category or feature of frequency based transaction data (e.g., number of purchases last week), each possible category or feature of amount based transaction data (e.g., amount of last purchase), each possible category or feature of time based transaction data (e.g., day over day increased amount of purchases (e.g., within a payment session or otherwise), each possible category or feature of session based transaction data (e.g., session open amount data), each possible category or feature of user behavior based transaction data (e.g., number of stores transacted within last week), each possible category or feature of graph based transaction data, and/or the like may be associated with one or more particular respective input neurons of the neural network and transaction feature data for the particular transaction feature may be operative to activate the associated input neuron(s)). The weight assigned to the output of each neuron may be initially configured using any suitable determinations that may be made by a custodian or processor of the model (e.g., server 210) based on the data available to that custodian.

The initial configuring of the learning engine or model (e.g., the initial weighting and arranging of neurons of a neural network of the learning engine) may be done using any suitable data accessible to a custodian of the model. For example, a model custodian may be operative to capture any suitable initial background data about a particular customer or all known customers or a subset of all known customers or all known transactions or a subset of all known transactions as well as the result or truth for each transaction (e.g., authorized or fraudulent) in any suitable manner from any suitable sources (e.g., SP subsystem 200, one or more CM subsystems 300, one or more customer devices 100, one or more third party subsystems, or the like). Any suitable training methods or algorithms (e.g., learning algorithms) may be used to train the neural network of the learning engine, including, but not limited to, Back Propagation, Resilient Propagation, Genetic Algorithms, Simulated Annealing, Levenberg, Nelder-Meade, and/or the like. Such training methods may be used individually and/or in different combinations to get the best performance from a neural network. A loop (e.g., a receipt and train loop) of receiving transaction feature data and a result/truth for a transaction and then training the model using the received transaction feature data and result/truth may be repeated any suitable number of times for more effectively training the learning engine, where the received transaction feature data and the received result/truth received of different receipt and train loops may be for different customers or for the same customer (e.g., for different transactions) and/or may be received from the same source or from different sources. The number and/or type(s) of the one or more types of transaction features for which transaction feature data may be received for one receipt and train loop may be the same or different in any way(s) than the number and/or type(s) of the one or more transaction features for which transaction feature data may be received for a second receipt and train loop.

### Description of FIG. 6

FIG. 6 is a flowchart of an illustrative process 600 for customizing a payment session experience. At operation 602, it may be determined whether a new purchase attempt has been made by a particular customer (e.g., as may be received by store 265). If a new purchase attempt has been determined to have been made at operation 602, process 600 may advance to operation 604 and it may be determined whether or not an active payment session exists for that particular customer. If no payment session is determined to be currently pending for that particular customer, process 600 may advance from operation 604 to operation 606 and a payment session eligibility model may be utilized to determine if a new payment session ought to be made available to the particular customer for the particular transaction of the new purchase attempt detected at operation 602 (e.g., using any suitable payment session eligibility model (“SEM”) 606m of server 210 (e.g., using any suitable request 239 and response 237 communications between store 265 and server 210 (e.g., using any suitable transaction feature data that may be specific to the particular customer and/or the particular transaction (e.g., “dsid” and/or “store_front_id” and/or “buy_amount” and/or “card_type” and/or “flow_step” and/or “delinquent_score” and/or the like)))). If the result of operation 606 is negative (e.g., if the customer should not be eligible for a payment session), then process 600 may advance to operation 608 and details of the transaction of the new purchase attempt may be communicated to an appropriate CM for immediate authorization of that transaction (e.g., by sending suitable SP authorization request data from store 265 or otherwise from SP subsystem 200 to CM subsystem 300), and then process 600 may return to operation 602.

However, if the result of operation 606 is positive (e.g., if the customer should be eligible for a payment session), then process 600 may advance to operation 610 and the SP product of the new purchase attempt may be provided to the customer and details of the transaction for that purchase attempt may be associated with a new payment session that may be initiated for the particular customer. Additionally, along with operation 610, process 600 may advance to operation 612 and a payment session value amount limit model may be utilized to determine an appropriate value amount limit that ought to define an amount limit of the new payment session (e.g., using any suitable payment session value amount limit model (“SALM”) 612m of server 210 (e.g., using any suitable request 239 and response 237 communications between store 265 and server 210 (e.g., using any suitable transaction feature data that may be specific to the particular customer and/or the particular transaction (e.g., “dsid” and/or “store_front_id” and/or “buy_amount” and/or “buys_last_x_hours” and/or “card_type” and/or “flow_step” and/or “session_amount_cap” and/or “model_version” and/or the like)))). Additionally, along with operation 610 and/or operation 612, process 600 may advance to operation 614 and a payment session time limit model may be utilized to determine an appropriate time limit that ought to define a time limit of the new payment session (e.g., using any suitable payment session time limit model (“STLM”) 614m of server 210 (e.g., using any suitable request 239 and response 237 communications between store 265 and server 210 (e.g., using any suitable transaction feature data that may be specific to the particular customer and/or the particular transaction (e.g., “dsid” and/or “store_front_id” and/or “buy_amount” and/or “buys_last_x_hours” and/or “card_type” and/or “flow_step” and/or “session_len_cap” and/or “timestamp” and/or “model_version” and/or the like)))). In some embodiments, any two or each one of operations 606, 612, and 614 may be achieved in a single set of suitable request 239 and response 237 communications between store 265 and server 210 (e.g., using any suitable transaction feature data).

After such operations 604, 606, 610, 612, and 614, a payment session has been activated and customized for the particular customer and its particular transaction situation as detected at operation 602. Then, at operation 616, it may be determined whether or not such a customized payment session should remain active (e.g., by determining whether or not the value amount limit and/or the time limit has been reached. If so, process 600 may advance from operation 616 to operation 618, where all transactions of the active payment session may be aggregated and the payment session may be terminated and details of the aggregated transaction may be communicated to an appropriate CM for immediate authorization of that aggregated transaction (e.g., by sending suitable SP authorization request data from store 265 or otherwise from SP subsystem 200 to CM subsystem 300), and then process 600 may return to operation 602. Alternatively, if it is determined that the active payment session should remain pending at operation 616, then process 600 may advance from operation 616 back to operation 602 in order to determine if another new purchase attempt has been made by the particular customer. If a payment session is determined to be currently pending for the particular customer at operation 604, process 600 may advance from operation 604 to operation 620 and a determination may be made as to whether or not the active payment session detected at operation 604 may accommodate the transaction of the new purchase attempt detected at operation 602 (e.g., by determining if the value amount of the new purchase attempt in combination with the sum of all transactions already associated with the active payment session exceeds the value amount limit of the active payment session (e.g., at all or by a particular threshold amount)). As just one example, if it is determined at operation 620 that the new transaction purchase attempt may not be accommodated by the active payment session, then process 600 may advance from operation 620 to operation 622, where details of the transaction of the new purchase attempt may be communicated to an appropriate CM for immediate authorization of that transaction (e.g., by sending suitable SP authorization request data from store 265 or otherwise from SP subsystem 200 to CM subsystem 300), and then process 600 may return to operation 602, while maintaining the pendency of the active payment session. As another example, if it is determined at operation 620 that the new transaction purchase attempt may not be accommodated by the active payment session, then process 600 may advance from operation 620 to operation 622, where details of the transaction of the new purchase attempt may be communicated to an appropriate CM for immediate authorization of that transaction (e.g., by sending suitable SP authorization request data from store 265 or otherwise from SP subsystem 200 to CM subsystem 300), and all other transactions of the active session may be aggregated, and the active session may be closed, and the aggregated transactions (including or not including the new transaction) may be sent to an appropriate CM for authorization, and then process 600 may return to operation 602 with no payment session being active.

However, if it is determined at operation 620 that the new transaction purchase attempt may be accommodated by the active payment session, then process 600 may advance from operation 620 to operation 624 and the SP product of the new purchase attempt may be provided to the customer and details of the transaction for that purchase attempt may be associated with the already active payment session (e.g., the payment session detected at operation 604). Additionally, along with operation 624, process 600 may advance to another iteration of operation 612 and a payment session value amount limit model may be utilized to determine an appropriate updated value amount limit that ought to define an updated amount limit of the already active payment session (e.g., using any suitable payment session value amount limit model of server 210 (e.g., using any suitable request 239 and response 237 communications between store 265 and server 210 (e.g., using any suitable transaction feature data that may be specific to the particular customer and/or the particular transaction, where such transaction feature data may include transaction feature data that was not available to server 210 and/or any of its models when the initial value amount limit was determined for the active payment session (e.g., at an initial iteration of operation 612)))), wherein the value amount limit model being used may have been refreshed in between the first iteration of operation 612 and this additional iteration of operation 612 and/or altogether different value amount limit models may be used between these different iterations of operation 612 for a particular payment session. Additionally, along with operation 624 and operation 612, process 600 may advance to another iteration of operation 614 and a payment session time limit model may be utilized to determine an appropriate updated time limit that ought to define an updated time limit of the already active payment session (e.g., using any suitable payment session time limit model of server 210 (e.g., using any suitable request 239 and response 237 communications between store 265 and server 210 (e.g., using any suitable transaction feature data that may be specific to the particular customer and/or the particular transaction, where such transaction feature data may include transaction feature data that was not available to server 210 and/or any of its models when the initial time limit was determined for the active payment session (e.g., at an initial iteration of operation 614)))), where the time limit model being used may have been refreshed in between the first iteration of operation 614 and this additional iteration of operation 614 and/or altogether different time limit models may be used between these different iterations of operation 614 for a particular payment session. In some embodiments, any two or each one of operations 624, 612, and 614 may be achieved in a single set of suitable request 239 and response 237 communications between store 265 and server 210 (e.g., using any suitable transaction feature data).

If no new purchase attempt is determined to have been received at operation 602, process 600 may advance from operation 602 to operation 626, where it may be determined whether or not an active payment session exists for the particular customer. If no payment session is determined to be currently pending for the particular customer at operation 626, process 600 may advance from operation 626 back to operation 602. However, if a payment session is determined to be currently pending for the particular customer at operation 626, process 600 may advance from operation 626 to yet another iteration of operation 612 and/or operation 614, such that a periodic potential update of the amount limit and/or time limit of the active payment session may be enabled.

It is understood that the operations shown in process 600 of FIG. 6 are only illustrative and that existing operations may be modified or omitted, additional operations may be added, and the order of certain operations may be altered. Therefore, SP subsystem 200 may be configured to provide a new layer of security and/or to provide a more seamless user experience when a new purchase attempt by a particular customer may be detected, whereby a new customized payment session may be initiated for handling the new purchase transaction or whereby one or more characteristics (e.g., value amount limit and/or time limit) of an active payment session may be potentially updated (e.g., further customized) for handling the new purchase transaction. Using particular test/training transactional data from previous transactions with known outcomes, a session eligibility model may be generated/trained for appropriately predicting/determining whether or not a new attempted transaction by a particular customer ought to be afforded a new payment session (e.g., the output of such a model may be a binary classification of positive (afford a payment session) or negative (do not afford a payment session)). Using particular test/training transactional data from previous transactions with known outcomes, a session time limit model may be generated/trained for appropriately predicting/determining a maximum amount of time during which a payment session ought to be afforded for the particular customer in the particular situation detected (e.g., the output of such a model may be 10 minutes, 2 hours, 8 hours, 12 hours, 1 day, 2 days, 7 days, 10 days, 14 days, and/or any other suitable time limit). Using particular test/training transactional data from previous transactions with known outcomes, a session value amount limit model may be generated/trained for appropriately predicting/determining a maximum amount of value that a payment session may allow to be aggregated for the particular customer in the particular situation detected (e.g., the output of such a model may be $5, $10, $20, $50, $100, $200, $500, $1,000, and/or any other suitable value amount limit). By creating one or more models that have been generated using trusted test data, such model(s) may be relied on by the system to accurately predict an appropriate eligibility, time limit, and/or amount limit for a payment session for a particular customer in a particular transaction situation, which may enable server 210 to efficiently and effectively balance risk and reward for customizing an appropriate payment session experience for a particular customer in a particular transaction situation with an SP. By enabling certain characteristics of an active payment session to be adjusted in-session (e.g., by potentially updating a time limit and/or a value limit of an active session during the session itself based on new transaction data made available to the one or more models (e.g., new purchase attempt data for the particular customer associated with the active payment session)), the payment session may be further customized and dynamically adjusted to further mitigate risk by extending or reducing the viability of certain payment sessions accordingly (e.g., by analyzing the relative values and/or timing of multiple transaction attempts within a payment session, by analyzing new data about customer purchasing patterns, SP product purchaser patterns, etc.).

### Description of FIGS. 7, 7A, and 7B

While a goal may be to customize a payment session using one or more models in order to decrease the number of sessions, there may be utility in reducing a session length or terminating a session when the benefit of closing a session (e.g., authorizing the session and recouping the value amount of the session from the CM subsystem) may outweigh the benefit of keeping the session active (e.g., avoiding the transaction and operating costs associated with terminating the session). Therefore, in some embodiments, in addition to or as an alternative to employing a session amount limit model (e.g., model 612m of operation 612 of process 600 of FIG. 6) and/or a session time limit model (e.g., model 614m of operation 614 of process 600 of FIG. 6), a session utility model (e.g., a session utility model (“SUM”) 711m of server 210 at an operation 711 of a process 700 of FIG. 7) may be developed and employed for use in determining or predicting a probability of the utility of continuing an active payment session (e.g., a likelihood that the benefit of keeping the session active will outweigh the benefit of terminating the active session (e.g., by attempting to minimize the idle time (e.g., waiting time between transactions of a session))). Therefore, a goal may be to customize the idle time of a payment session afforded by the service provider to a customer for reducing the risk associated with the loan(s) of aggregated transactions of the payment session while also increasing the efficiency and effectiveness of the payment sessions provided by the service provider (e.g., to reduce transaction fees and/or operation traffic that may be associated with requesting transaction authorization, and/or to provide a more efficient and seamless user experience). A session utility probability may be identified using one or more payment session models based on particular transaction data associated with a particular customer and a particular transaction purchase attempt, such that a payment session may be personalized to a particular customer and/or different types of payment sessions may be afforded to different customers and/or different payment sessions may be afforded to a particular customer over time based on that particular customer's behavior. In some embodiments, certain characteristics of a payment session may be dynamically changed during the pendency of that payment session based on new real-time data that may be made available to the system. Use of one or more machine learning models may enable a data driven session utility model for customizing a payment session as opposed to a pre-defined payment session, a dynamically refreshable active payment session as opposed to a static payment session, and/or a probability based payment session as opposed to a rule based payment session.

Such a session utility model may be a probability based model or any other suitable model, which may be operative to compute the probability P that an active session should continue (e.g., the model may be operative to compute an output probability P of a value 0 that may be indicative of 0% probability that the benefit of continuing with an active session will outweigh the benefit of terminating the active session, an output probability P of a value 1 that may be indicative of 100% probability that the benefit of continuing with an active session will outweigh the benefit of terminating the active session, or an output probability P of any value between 0 and 1 that may be indicative of any other suitable percentage probability that the benefit of continuing with an active session will outweigh the benefit of terminating the active session). As just one example, output probability P may be a model functionfof any suitable model inputs or machine learning features or model input features, including, but not limited, to the session length (“SL”) of the currently active payment session of interest (e.g., the length of time during which the session has been currently active), the session amount (“SA”) of the currently active payment session of interest (e.g., the total value amount of all the transaction of the currently active session), any suitable user features (“UF”) that may be associated with the current payment session, and/or the like. Such user features may include any suitable user features for the current payment session, including, but not limited to, any information about the payment instrument(s) associated with one or more of the transactions of the active payment session, any information about the products or services being purchased for the one or more of the transactions of the active payment session, the number of transactions of the active payment session, the average value amount of each transaction of the active payment session, an N-day average total value amount of all transactions conducted by the user of the active payment session for any suitable historical duration of time N, an N-day average minimum value amount of all transactions conducted by the user of the active payment session for any suitable historical duration of time N, an N-day average maximum value amount of all transactions conducted by the user of the active payment session for any suitable historical duration of time N, an N-day average number of transactions conducted by the user of the active payment session for any suitable historical duration of time N, an N-day minimum interval between consecutive transactions conducted by the user of the active payment session for any suitable historical duration of time N, an N-day maximum interval between consecutive transactions conducted by the user of the active payment session for any suitable historical duration of time N, an N-day average interval between consecutive transactions conducted by the user of the active payment session for any suitable historical duration of time N, an N-day number of billing accounts associated with the user of the active payment session for any suitable historical duration of time N, an N-day number of successful transaction authorizations associated with the user of the active payment session for any suitable historical duration of time N, an N-day ratio of successful transaction authorizations to total attempted transaction authorizations associated with the user of the active payment session for any suitable historical duration of time N, an N-day number of a first type of purchase (e.g., in-music-application purchase) made by the user of the active payment session for any suitable historical duration of time N, an N-day number of a second type of purchase (e.g., in-movie-application purchase) made by the user of the active payment session for any suitable historical duration of time N, an N-day list of types of purchases (e.g., genres) made by the user of the active payment session for any suitable historical duration of time N, an N-day list of content types of goods or services for purchases made by the user of the active payment session for any suitable historical duration of time N, and/or any other suitable user feature model input data. Therefore, such a session utility model (e.g., SUM 711m) may be trained to provide a model function ƒ(SL, SA, UF)=P probability.

Such a session utility model may be trained to model function fusing any suitable supervised approach, including, but not limited to, logistic regression, random forest, gradient boosted decision trees, deep learning (e.g., LS™), and/or the like. However, in order to train such a session utility model using historical transaction data as model input features, accurate model outputs or model labels must first be determined for use in such training. For example, determination of model input features and model labels to be used as model training sets for training a session utility model may be determined using a process 750 of FIG. 7A, which may be described with respect to an exemplary timeline 790 of historical transaction data of FIG. 7B. As shown in FIG. 7B, for example, exemplary timeline 790 of historical transaction data may include a first transaction C1 of a first transaction amount TA1 at a first transaction time I1 (e.g., on February 1^{st}), a second transaction C2 of a second transaction amount TA2 at a second transaction time I2 (e.g., on February 1^{st}) that may occur at a duration of waiting time WT2 after first transaction time I1, a third transaction C3 of a third transaction amount TA3 at a third transaction time I3 (e.g., on March 1^{st}) that may occur at a duration of waiting time WT3 after second transaction time I2, a fourth transaction C4 of a fourth transaction amount TA4 at a fourth transaction time I4 (e.g., on March 2^{nd}) that may occur at a duration of waiting time WT4 after third transaction time I3, and a fifth transaction C5 of a fifth transaction amount TA5 at a fifth transaction time I5 (e.g., on March 3^{rd}) that may occur at a duration of waiting time WT5 after fourth transaction time I4 and that may occur at a duration of waiting time WT6 prior to a sixth transaction time I6 at which a sixth transaction C6 of a sixth transaction amount TA6 may occur. The data of timeline 790 may be associated with transactions made by a particular user with a particular payment instrument for one or more particular products, and additional data indicative of such a user, payment instrument, product(s), and/or the like may be provided by the data of timeline 790.

The historic data of timeline 790 of FIG. 7B may be used by process 750 of FIG. 7A to define appropriate model input features and model labels to be used as model training sets for training a session utility model (e.g., model 711m). At an initial iteration of operation 751, a session may be defined with any suitable transaction by a user (e.g., using any suitable historical transaction data for that user, such as the data of timeline 790). For example, such an initial session may be defined with first transaction C1. Then, at operation 753, the next consecutive transaction by the user may be added to the session. For example, if the session was previously defined at operation 751 by transaction C1, then transaction C2, which is consecutively after transaction C1 in timeline 790, may be added to the session at operation 753. Next, at operation 755, any suitable process(es) may be used to determine whether the current session (e.g., as defined at operation 753) has a session utility or session utility value or session value that is greater than any suitable utility threshold. For example, the product of the total session length of the current session (e.g., duration in time between the transaction time of the first transaction of the current session and the transaction time of the last transaction of the current session (e.g., waiting time WT2)) and the total value amount of the current session (e.g., the sum of the transaction amounts of each transaction of the current session (e.g., TA1+TA2)) may be compared to any suitable utility threshold, and, if such a product is greater than the utility threshold, then the current session may be determined not to be useful and process 750 may proceed from operation 755 to operation 757. However, if such a product is not greater than the utility threshold, then the current session may be determined to be useful and process 750 may proceed from operation 755 back to another iteration of operation 753 for extending the current session (e.g., by adding transaction C3, which is consecutively after transaction C2 in timeline 790, to the current session at this other iteration of operation 753) and, then, analyzing that updated current session at another iteration of operation 755, and so on and so forth until process 700 advances from an iteration of operation 755 to operation 757. In such an example, the utility threshold may be determined by grid search or parameter sweeping or any other suitable hyperparameter optimization technique of varying at least the utility threshold in order to optimize one or more characteristics of process 750 (e.g., to maximize session length, to maximize session amount, to minimize number of sessions, and/or to minimize idle time in between transactions (e.g., to minimize the idle time or waiting time between two consecutive transactions) of the current session whose session utility value is to not surpass the utility threshold (e.g., longer idle times may be used for frequent purchasing customers and shorter idle times may be used for infrequent purchasing customers)), which may be useful for enabling the training of a session utility model that may be operative to predict an optimal session length and/or session amount to reduce idle time. Such a comparison at operation 755 may provide a constraint to limit session length/session value amount to minimize idle time. Grid search of the threshold may provide appropriate cost/benefit analysis. In certain embodiments, even though operation 755 may be determined by session length and session value amount with respect to a threshold, various other input features for the session (e.g., user features) may be used to train a session utility model (e.g., at operations 759 and 769) to provide a personalized perspective at an individual level, and user features of future sessions may be used as inputs to such a model when online (e.g., at operation 711). In some embodiments, rather than comparing a threshold to a product of the total session length of the current session and the total value amount of the current session, operation 755 may be configured to make any other suitable comparisons, such as to compare the total session length of the current session to a first threshold and to compare the total value amount of the current session to a second threshold and advance in a particular manner based on the result of each comparison (e.g., advance to operation 757 only if each comparison is larger than its respective threshold). In some embodiments, a particular threshold used at operation 755 may be used for all iterations of process 750 for all sessions of all users. Alternatively, a different threshold may be determined on a per-user basis (e.g., based on each user's spending pattern (e.g., high spending users may result in use of a higher threshold)). Analysis of operation 755 may be carried out (e.g., mostly) for sessionization. Using session value is one way. Using transaction gaps to separate sessions can be another way. Alternatively or additionally, any suitable clustering technique in machine learning may be used to group transactions into sessions. A session value of a current session may be compared with a session value of a previous session so that a decision may be made based on a cost/benefit analysis of the two possible sessions (e.g., a time series perspective may be included as part of historical features during training). In some embodiments, an operation (not shown) can be added optionally after operation 755 to “remove last transaction from current session” when threshold is reached (e.g., between operation 755 and operation 757) such that a current session may be determined to continue or not based upon a consecutively next transaction during training.

If the session value is determined to be larger than the utility threshold at operation 755, then process 750 may advance to operation 757, where process 750 may label the current session (e.g., as defined by the most recent operation 753) to be negative (e.g., to define the label or output of probability P to be a value 0 that may be indicative of 0% probability that the benefit of continuing with the current session will outweigh the benefit of terminating the active session), and where process 750 may label the previous session (e.g., as defined by the 2^{nd} most recent operation 753 or, if non-existent, by operation 751) to be positive (e.g., to define the label or output of probability P to be a value 1 that may be indicative of 100% probability that the benefit of continuing with the previous session will outweigh the benefit of terminating the previous session). Then, process 750 may proceed from operation 757 to operation 759, where process 750 may obtain or define or generate the appropriate model input features for each session labelled at operation 757. Then, process 750 may proceed from operation 759 back to a new iteration of operation 751 at which a new transaction may be selected to define an initial new session (e.g., the transaction added at the last iteration of operation 753 may be used to define the new session at the next iteration of operation 751). Therefore, operations 751, 753, and 755 may be referred to as carrying out a transaction sessionization subprocess 761 of process 750, where one or more transactions may be grouped as a session that may be analyzed for determining its utility. Additionally, operations 757 and 759 may be referred to as carrying out a feature/label extraction subprocess 765 of process 750, where an appropriate label and a set of model input features may be obtained for each one of a current session and a previous session may each be appropriately labeled. Moreover, at any suitable moment after an appropriate label and model input features have been obtained for at least one session, process 750 may also include an operation 769 where at least one session utility model (e.g., SUM 711m) may be trained using extraction data for one, some, or each model (e.g., using the model input features of a session as inputs and the label of the session as an output). In some embodiments, if the session value is determined to be not larger than the utility threshold at operation 755, then the current session may be determined to be useful and process 750 may proceed from operation 755 back to another iteration of operation 753 for extending the current session, but first may conduct an intermediary operation (not shown between returning from operation 755 to another iteration of operation 753) where process 750 may label the current session (e.g., as defined by the most recent operation 753) to be positive (e.g., to define the label or output of probability P to be a value 1 that may be indicative of 100% probability that the benefit of continuing with the current session will outweigh the benefit of terminating the current session).

Following timeline 790, at least one implementation of process 750 may be carried out as follows. For example, as mentioned, at an initial iteration of operation 751, an initial session may be defined with first transaction C1, and, then, at operation 753, transaction C2, which is consecutively after transaction C1 in timeline 790, may be added to the session. Next, at operation 755, it may be determined that the session value of the current session, which may include transactions C1 and C2, is not greater than a utility threshold, such that process 750 may proceed to another iteration of operation 753, at which transaction C3, which is consecutively after transaction C2 in timeline 790, may be added to the session. Next, at another iteration of operation 755, it may be determined that the session value of the current session, which may include transactions C1, C2, and C3, is greater than a utility threshold, such that process 750 may proceed to operation 757. At such an iteration of operation 757, the current session including transactions C1, C2, and C3 may be labeled as negative (e.g., probability P=0) and the previous session including transactions C1 and C2 may be labeled as positive (e.g., probability P=1). Then, at operation 759, a set of model input features may be defined for each one of those sessions. For example, a first set of model input features may be defined for the previous session of transactions C1 and C2 that was labeled as positive (e.g., positive payment session PS1 of FIG. 7B), where such a first set of model input features may include any suitable data, such as the session length SL of that session (e.g., waiting time WT2), the session amount SA of that session (e.g., the sum of transaction amounts TA1 and TA2), and any suitable user features UF of that session. Additionally, a second set of model input features may be defined for the current session of transactions C1, C2, and C3 that was labeled as negative, where such a second set of model input features may include any suitable data, such as the session length SL of that session (e.g., the sum of waiting times WT2 and WT3), the session amount SA of that session (e.g., the sum of transaction amounts TA1 and TA2 and TA3), and any suitable user features UF of that session. Then, after that iteration of operation 759, process 750 may return to another iteration of operation 751, where another initial session may be defined with another initial transaction, such as third transaction C3 (e.g., the transaction added at the last iteration of operation 753), and, then, at next iteration of operation 753, transaction C4, which is consecutively after transaction C3 in timeline 790, may be added to the session. Next, at operation 755, it may be determined that the session value of the current session, which may include transactions C3 and C4, is not greater than a utility threshold, such that process 750 may proceed to another iteration of operation 753, at which transaction C5, which is consecutively after transaction C4 in timeline 790, may be added to the session. Next, at another iteration of operation 755, it may be determined that the session value of the current session, which may include transactions C3 and C4 and C5, is not greater than a utility threshold, such that process 750 may proceed to another iteration of operation 753, at which transaction C6, which is consecutively after transaction C5 in timeline 790, may be added to the session. Next, at another iteration of operation 755, it may be determined that the session value of the current session, which may include transactions C3, C4, C5, and C6, is greater than a utility threshold, such that process 750 may proceed to operation 757. At such an iteration of operation 757, the current session including transactions C3, C4, C5, and C6 may be labeled as negative (e.g., probability P=0) and the previous session including transactions C3, C4, and C5 may be labeled as positive (e.g., probability P=1). Then, at operation 759, a set of model input features may be defined for each one of those sessions. For example, a third set of model input features may be defined for the previous session of transactions C3, C4, and C5 that was labeled as positive (e.g., positive payment session PS2 of FIG. 7B), where such a third set of model input features may include any suitable data, such as the session length SL of that session (e.g., the sum of waiting times WT4 and WT5), the session amount SA of that session (e.g., the sum of transaction amounts TA3 and TA4 and TA5), and any suitable user features (IF of that session. Additionally, a fourth set of model input features may be defined for the current session of transactions C3, C4, C5, and C6 that was labeled as negative, where such a fourth set of model input features may include any suitable data, such as the session length SL of that session (e.g., the sum of waiting times WT4 and WT5 and WT6), the session amount SA of that session (e.g., the sum of transaction amounts TA3 and TA4 and TA5 and TA6), and any suitable user features UF of that session. Moreover, at any suitable moment, the labels and sets of model input features may be used to train at least one session utility model. For example, a session utility model (e.g., an SUM 711m) may be trained by each one of a first combination of the first set of model input features and a positive output label for the session of transactions C1 and C2, a second combination of the second set of model input features and a negative output label for the session of transactions C1-C3, a third combination of the third set of model input features and a positive output label for the session of transactions C3-C5, and a fourth combination of the fourth set of model input features and a negative output label for the session of transactions C3-C6.

Once at least one session utility model has been trained for at least one timeline of historical data (e.g., by process 750 for at least timeline 790), a process may be carried out for customizing a payment session experience using such a session utility model. FIG. 7 is a flowchart of an illustrative process 700 for customizing a payment session experience using at least one session utility model. At operation 702, it may be determined whether a new purchase attempt has been made by a particular customer (e.g., as may be received by store 265). If a new purchase attempt has been determined to have been made at operation 702, process 700 may advance to operation 704 and it may be determined whether or not an active payment session exists for that particular customer. If no payment session is determined to be currently pending for that particular customer, process 700 may advance from operation 704 to operation 706 and a payment session eligibility model may be utilized to determine if a new payment session ought to be made available to the particular customer for the particular transaction of the new purchase attempt detected at operation 702 (e.g., using any suitable payment session eligibility model 606m of server 210 (e.g., using any suitable request 239 and response 237 communications between store 265 and server 210 (e.g., using any suitable transaction feature data that may be specific to the particular customer and/or the particular transaction (e.g., “dsid” and/or “store_front_id” and/or “buy_amount” and/or “card_type” and/or “flow_step” and/or “delinquent_score” and/or the like)))). If the result of operation 706 is negative (e.g., if the customer should not be eligible for a payment session), then process 700 may advance to operation 708 and details of the transaction of the new purchase attempt may be communicated to an appropriate CM for immediate authorization of that transaction (e.g., by sending suitable SP authorization request data from store 265 or otherwise from SP subsystem 200 to CM subsystem 300), and then process 700 may return to operation 702.

However, if the result of operation 706 is positive (e.g., if the customer should be eligible for a payment session), then process 700 may advance to operation 710 and the SP product of the new purchase attempt may be provided to the customer and details of the transaction for that purchase attempt may be associated with a new payment session that may be initiated for the particular customer. Additionally, along with operation 710, process 700 may advance to operation 711 and a session utility model may be utilized to determine whether the active session ought to be continued or terminated (e.g., using any suitable session utility model 711m of server 210 (e.g., using any suitable request 239 and response 237 communications between store 265 and server 210 (e.g., using any suitable transaction feature data that may be specific to the particular customer and/or the particular transaction (e.g., “dsid” and/or “store_front_id” and/or “buy_amount” and/or “buys_last_x_hours” and/or “card_type” and/or “flow_step” and/or “session_amount_cap” and/or “model_version” and/or the like)))). For example, at operation 711, various suitable model input features of the current active session may be provided as inputs to a previously trained session utility model, where such model input features may include the session amount SA of the current active session (e.g., the sum of all transaction amounts of the current active session), the session length SL of the current active session (e.g., the sum of all waiting times of the current active session), and any suitable user features UIF associated with the current active session, and the session utility model may be operative to provide an output probability P based on those model input features, where such output probability P may be any suitable value between 0 and 1 (e.g., the model may be operative to compute an output probability P of a value 0 that may be indicative of a 0% probability prediction that the benefit of continuing with an active session will outweigh the benefit of terminating the active session, an output probability P of a value 1 that may be indicative of a 100% probability prediction that the benefit of continuing with the active session will outweigh the benefit of terminating the active session, or an output probability P of any value between 0 and 1 that may be indicative of any other suitable percentage probability prediction that the benefit of continuing with the active session will outweigh the benefit of terminating the active session). Operation 711 may include not only using such a session utility model to generate such a prediction with an output probability P based on the appropriate model input features, but also comparing the value of that output probability P to any suitable session utility model threshold θ, which may be set as any suitable value (e.g., 0.5, 0.6, 0.7, 0.8, 0.9, etc.).

After such operations 704, 706, and 710, a payment session has been activated and customized for the particular customer and its particular transaction situation as detected at operation 702. Then, at operation 711, it may be determined whether or not such an active payment session should remain active (e.g., by determining whether or not the value of the prediction of output probability P of a session utility model for the active payment session satisfies a session utility model threshold θ (e.g., by determining whether or not the benefit of continuing with the active session likely outweighs the cost of continuing with the active session by a particular threshold amount)). If it is determined that the active session ought to be terminated, process 700 may advance from operation 711 to operation 718, where all transactions of the active payment session may be aggregated and the payment session may be terminated and details of the aggregated transaction may be communicated to an appropriate CM for immediate authorization of that aggregated transaction (e.g., by sending suitable SP authorization request data from store 265 or otherwise from SP subsystem 200 to CM subsystem 300), and then process 700 may return to operation 702. Alternatively, if it is determined that the active payment session should continue to remain pending at operation 711, then process 700 may advance from operation 711 back to operation 702 (e.g., via an operation 715 (e.g., at which a time limit for a background check may be defined or updated)) in order to determine if another new purchase attempt has been made by the particular customer. If a payment session is determined to be currently pending for the particular customer at operation 704, process 700 may advance from operation 704 to operation 720 and a determination may be made as to whether or not the active payment session detected at operation 704 may accommodate the transaction of the new purchase attempt detected at operation 702 (e.g., by determining if the value amount of the new purchase attempt in combination with the sum of all transactions already associated with the active payment session exceeds a value amount limit of the active payment session (e.g., at all or by a particular threshold amount)). As just one example, if it is determined at operation 720 that the new transaction purchase attempt may not be accommodated by the active payment session, then process 700 may advance from operation 720 to operation 722, where details of the transaction of the new purchase attempt may be communicated to an appropriate CM for immediate authorization of that transaction (e.g., by sending suitable SP authorization request data from store 265 or otherwise from SP subsystem 200 to CM subsystem 300), and then process 700 may return to operation 702, while maintaining the pendency of the active payment session. As another example, if it is determined at operation 720 that the new transaction purchase attempt may not be accommodated by the active payment session, then process 700 may advance from operation 720 to operation 722, where details of the transaction of the new purchase attempt may be communicated to an appropriate CM for immediate authorization of that transaction (e.g., by sending suitable SP authorization request data from store 265 or otherwise from SP subsystem 200 to CM subsystem 300), and all other transactions of the active session may be aggregated, and the active session may be closed, and the aggregated transactions (e.g., including or not including the new transaction) may be sent to an appropriate CM for authorization, and then process 700 may return to operation 702 with no payment session being active.

However, if it is determined at operation 720 that the new transaction purchase attempt may be accommodated by the active payment session, then process 700 may advance from operation 720 to operation 724 and the SP product of the new purchase attempt may be provided to the customer and details of the transaction for that purchase attempt may be associated with the already active payment session (e.g., the payment session detected at operation 704) (alternatively, process 700 may not include an operation 720 and process 700 may proceed from operation 704 to operation 724 when an active session for a user is determined to exist at operation 704). Additionally, along with operation 724, process 700 may advance to another iteration of operation 711 and a session utility model may be utilized to determine whether the active session updated at operation 724 ought to continue or be terminated (e.g., using any suitable session utility model (e.g., SUM 711m) of server 210 (e.g., using any suitable request 239 and response 237 communications between store 265 and server 210 (e.g., using any suitable transaction feature data that may be specific to the particular customer and/or the particular transaction, where such transaction feature data may include transaction feature data that was not available to server 210 and/or any of its models when a session utility model was first used for the active payment session (e.g., at an initial iteration of operation 711)))), wherein the session utility model being used may have been refreshed in between the first iteration of operation 711 and this additional iteration of operation 711 and/or altogether different session utility models may be used between these different iterations of operation 711 for a particular payment session.

If no new purchase attempt is determined to have been received at operation 702, process 700 may advance from operation 702 to operation 726, where it may be determined whether or not an active payment session exists for the particular customer. If no payment session is determined to be currently pending for the particular customer at operation 726, process 700 may advance from operation 726 back to operation 702. However, if a payment session is determined to be currently pending for the particular customer at operation 726, process 700 may advance from operation 726 to an operation 728, where it may be determined whether or not the time limit defined or updated at the most recent iteration of operation 715 has been exceeded. If the time limit is determined to have been exceeded at operation 728, then process 700 may proceed to operation 718 for terminating the active session. Otherwise, if the time limit is determined to have not yet been exceeded at operation 728, then process 700 may proceed back to operation 702. When a session utility model of operation 711 uses a particular current set of model input features of a current active session and a particular current session utility model threshold θ for making a determination to continue the active session and advance from operation 711 to operation 715, that iteration of operation 715 may be operative to initially define or update an already defined termination session length (“TSL”) for the current active session being continued using any suitable technique. For example, a TSL may be defined or updated at operation 715 by using the same session utility model as used at the most recent iteration of operation 711 and the same current set of model input features of the current active session, and then by increasing the value of the length of the session length SL model input feature of that current set of model input features until the increased value of the session length SL results in the probability value of output P of the session utility model equaling or just falling below the current session utility model threshold θ as used at the most recent iteration of operation 711, and then using that increased value of the session length SL to define or update the time limit at operation 715. Then, at operation 728, it may be determined whether the current session length of the active session (e.g., the duration of time between the first transaction of the active payment session and the current time at operation 728) exceeds the time limit defined or updated at the most recent iteration of operation 715. Therefore, even when a new purchase attempt has not been received at operation 702, an active session may be terminated if a particular background check time limit has been exceeded. This may prevent an active session from continuing indefinitely or beyond a length of time determined to cause the active session to lose its utility.

It is understood that the operations shown in process 700 of FIG. 7 are only illustrative and that existing operations may be modified or omitted, additional operations may be added, and the order of certain operations may be altered. Therefore, SP subsystem 200 may be configured to provide a new layer of security and/or to provide a more seamless user experience when a new purchase attempt by a particular customer may be detected, whereby a new customized payment session may be initiated for handling the new purchase transaction or whereby one or more characteristics (e.g., session utility probability value) of an active payment session may be determined (e.g., periodically) for determining whether to continue or terminate a currently active payment session. Using particular test/training transactional data from previous transactions with known outcomes, a session eligibility model may be generated/trained for appropriately predicting/determining whether or not a new attempted transaction by a particular customer ought to be afforded a new payment session (e.g., the output of such a model may be a binary classification of positive (afford a payment session) or negative (do not afford a payment session)). Using particular test/training transactional data from previous transactions with known outcomes, a session utility model may be generated/trained for appropriately predicting/determining a probability of session utility for continuing an active payment session for the particular customer in the particular situation detected (e.g., the output of such a model may be any suitable output probability value between 0 and 1 or any other suitable range). By creating one or more models that have been generated using trusted test data, such model(s) may be relied on by the system to accurately predict an appropriate eligibility and session utility for a payment session for a particular customer in a particular transaction situation, which may enable server 210 to efficiently and effectively balance risk and reward for customizing an appropriate payment session experience for a particular customer in a particular transaction situation with an SP. By enabling certain characteristics of an active payment session to be adjusted in-session (e.g., by re-running a session utility model after each new purchase attempt and/or continuously and/or periodically monitoring a background check time limit for an active session during the session itself (e.g., based on new transaction data made available to one or more models (e.g., new purchase attempt data for the particular customer associated with the active payment session)), the payment session may be further customized and dynamically adjusted to further mitigate risk by extending or reducing the viability of certain payment sessions accordingly (e.g., by analyzing the relative values and/or timing of multiple transaction attempts within a payment session, by analyzing new data about customer purchasing patterns, SP product purchaser patterns, etc.).

### Further Description of FIGS. 1-7B

One, some, or all of the processes described with respect to FIGS. 1-7B may each be implemented by software, but may also be implemented in hardware, firmware, or any combination of software, hardware, and firmware. Instructions for performing these processes may also be embodied as machine- or computer-readable code recorded on a machine- or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and a data storage device (e.g., memory 104 of FIG. 2). In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device or subsystem to another electronic device or subsystem using any suitable communications protocol (e.g., the computer-readable medium may be communicated to electronic device 100 via communications circuitry 114 (e.g., as at least a portion of an application 103 and/or as at least a portion of an application 103a)). Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is understood that any, each, or at least one module or component or subsystem of system 1 may be provided as a software construct, firmware construct, one or more hardware components, or a combination thereof. For example, any, each, or at least one module or component or subsystem of system 1 may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules and components and subsystems of system 1 are only illustrative, and that the number, configuration, functionality, and interconnection of existing modules, components, and/or subsystems may be modified or omitted, additional modules, components, and/or subsystems may be added, and the interconnection of certain modules, components, and/or subsystems may be altered.

At least a portion of one or more of the modules or components or subsystems of system 1 may be stored in or otherwise accessible to an entity of system 1 in any suitable manner (e.g., in memory 104 of device 100 (e.g., as at least a portion of an application 103 and/or as at least a portion of an application 103a)). Any or all of the modules or other components of system 1 may be mounted on an expansion card, mounted directly on a system motherboard, or integrated into a system chipset component (e.g., into a “north bridge” chip).

Any or each module or component of system 1 may be a dedicated system implemented using one or more expansion cards adapted for various bus standards. For example, all of the modules may be mounted on different interconnected expansion cards or all of the modules may be mounted on one expansion card. Any or each module or component of system 1 may include its own processing circuitry and/or memory. Alternatively, any or each module or component of system 1 may share processing circuitry and/or memory with any other module.

As described above, one aspect of the present technology is the gathering and use of data available from various sources to customize payment sessions. The present disclosure contemplates that in some instances, this gathered data may include personal information data that uniquely identifies or can be used to contact or locate a specific person. Such personal information data can include demographic data, location-based data, telephone numbers, email addresses, social network identifiers, home addresses, office addresses, data or records relating to a user's health or level of fitness (e.g., vital signs measurements, medication information, exercise information, etc.) or purchase history, date of birth, or any other identifying or personal information.

The present disclosure recognizes that the use of such personal information data, in the present technology, can be used to the benefit of users. The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the United States, collection of or access to certain health data may be governed by federal and/or state laws, such as the Health Insurance Portability and Accountability Act (“HIPAA”); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location detection services, the present technology can be configured to allow users to select to “opt in” or “opt out” of participation in the collection of personal information data during registration for services or anytime thereafter. In addition to providing “opt in” or “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, customizing payment sessions can be made based on non-personal information data or a bare minimum amount of personal information, such as the content being requested by the device associated with a user, other non-personal information available to the device, or publicly available information.

While there have been described systems, methods, and computer-readable media for customizing payment sessions, it is to be understood that many changes may be made therein without departing from the spirit and scope of the subject matter described herein in any way. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for customizing a payment session using a management server, the method comprising:
defining, with the management server, a first historical session to comprise a first historical transaction of a historical transaction timeline of a historical user;
defining, with the management server, a second historical session to comprise the first historical transaction and a second historical transaction of the historical transaction timeline, wherein the second historical transaction is consecutively after the first historical transaction in the historical transaction timeline;
after the defining the second historical transaction, determining, with the management server, if a session utility value of the defined second historical session is greater than a historic session utility threshold;
when it is determined that the session utility value of the defined second historical session is greater than the historic session utility threshold, labeling, with the management server, the defined second historical session as a negative label and the defined first historical session as a positive label;
obtaining, with the management server, a first set of model input features for the defined first historical session and a second set of model input features for the defined second historical session; and
after the labeling and the obtaining, training a session utility model, with the management server, using the label and the set of model input features of at least one of the defined first historical session and the defined second historical session.

2. The method of claim 1, further comprising:
defining, with the management server, an active session to comprise at least a first active transaction of a current transaction timeline of a current user; and
after the defining, utilizing, with the management server, the trained session utility model to provide an output probability prediction for the defined active session based on a set of model input features of the defined active session.

3. The method of claim 2, further comprising:
after the utilizing, determining, with the management server, if the provided output probability prediction for the defined active session is greater than an active session utility threshold; and
when it is determined that the provided output probability prediction for the defined active session is not greater than the active session utility threshold, terminating, with the management server, the defined active session.

4. The method of claim 2, further comprising:
after the utilizing, determining, with the management server, if the provided output probability prediction for the defined active session is greater than an active session utility threshold; and
when it is determined that the provided output probability prediction for the defined active session is greater than the active session utility threshold, maintaining, with the management server, the defined active session.

5. The method of claim 4, wherein the maintaining comprises:
identifying, with the management server, a termination session length for the defined active session;
after the identifying, determining, with the management server, if the duration of the defined active session has exceeded the identified termination session length; and
when it is determined that the duration of the defined active session has exceeded the identified termination session length, terminating, with the management server, the defined active session.

6. The method of claim 2, wherein the defining the active session comprises defining the active session to comprise at least the first active transaction of the current transaction timeline and a second active transaction of the current transaction timeline, wherein the second active transaction is consecutively after the first active transaction in the current transaction timeline.

7. The method of claim 2, wherein the current user is the historical user.

8. The method of claim 2, wherein the current user is different than the historical user.

9. The method of claim 2, wherein the set of model input features of the defined active session comprises at least one of the following input features:
a sum of each transaction amount of each active transaction of the defined active session;
a sum of each waiting time of the defined active session; or
at least one user feature associated with the current user.

10. The method of claim 2, wherein the set of model input features of the defined active session comprises:
a sum of each transaction amount of each active transaction of the defined active session; and
a sum of each waiting time of the defined active session.

11. The method of claim 10, wherein the set of model input features of the defined active session further comprises at least one of the following types of user feature associated with the current user:
information indicative of a payment instrument associated with the first active transaction;
information indicative of a product being acquired with the first active transaction;
a number of active transactions of the defined active session;
an average transaction amount of each active transaction of the defined active session;
a daily average total value amount of all transactions conducted by the current user over a plurality of days;
a daily average minimum value amount of all transactions conducted by the current user over a plurality of days;
a daily average maximum value amount of all transactions conducted by the current user over a plurality of days;
a daily average number of transactions conducted by the current user over a plurality of days;
a minimum interval between consecutive transactions conducted by the current user over a historical duration of time;
a maximum interval between consecutive transactions conducted by the current user over a historical duration of time;
a number of billing accounts associated with the current user over a historical duration of time;
a number of successful transaction authorizations associated with the current user over a historical duration of time;
a ratio of successful transaction authorizations to total attempted transaction authorizations associated with the current user over a historical duration of time;
a number of a first type of purchase made by the current user over a historical duration of time;
a list of types of purchases made by the current user over a historical duration of time; or
a list of content types of products purchased by the current user over a historical duration of time.

12. The method of claim 2, wherein the set of model input features of the defined active session comprises at least one of the following types of user feature associated with the current user:
information indicative of a payment instrument associated with the first active transaction;
information indicative of a product being acquired with the first active transaction;
a number of active transactions of the defined active session;
an average transaction amount of each active transaction of the defined active session;
a daily average total value amount of all transactions conducted by the current user over a plurality of days;
a daily average minimum value amount of all transactions conducted by the current user over a plurality of days;
a daily average maximum value amount of all transactions conducted by the current user over a plurality of days;
a daily average number of transactions conducted by the current user over a plurality of days;
a minimum interval between consecutive transactions conducted by the current user over a historical duration of time;
a maximum interval between consecutive transactions conducted by the current user over a historical duration of time;
a number of billing accounts associated with the current user over a historical duration of time;
a number of successful transaction authorizations associated with the current user over a historical duration of time;
a ratio of successful transaction authorizations to total attempted transaction authorizations associated with the current user over a historical duration of time;
a number of a first type of purchase made by the current user over a historical duration of time;
a list of types of purchases made by the current user over a historical duration of time; or
a list of content types of products purchased by the current user over a historical duration of time.

13. The method of claim 1, wherein:
the first set of model input features for the defined first historical session comprises at least one of the following input features:
a sum of each transaction amount of each historical transaction of the defined first historical session;
a sum of each waiting time of the defined first historical session; or
any user feature associated with the historical user; and
the second set of model input features for the defined second historical session comprises at least one of the following input features:
a sum of each transaction amount of each historical transaction of the defined second historical session;
a sum of each waiting time of the defined second historical session; or
any user feature associated with the historical user.

14. The method of claim 1, wherein the session utility value of the defined second historical session comprises a product of a total session length of the second historical session and a total transaction value amount of the second historical session.

15. The method of claim 14, further comprising determining, with the management server, the historic session utility threshold by a hyperparameter optimization technique for at least one of maximizing session length, maximizing session total transaction value amount, or minimizing idle time between session transactions.

16. A non-transitory machine readable medium storing a program for execution by at least one processing unit of a management server, the program for customizing a payment session, the program comprising sets of instructions for:
carrying out a transaction sessionization subprocess for a historical payment session comprising two or more consecutive historical transactions of a historical transaction timeline of a historical user to determine a utility of the historical payment session;
carrying out a feature and label extraction subprocess for the historical payment session to determine a label of the historical payment session based on the determined utility of the historical payment session and to identify one or more features of the historical payment session; and
carrying out a training subprocess to train a session utility model using the determined label of the historical payment session and the one or more identified features of the historical payment session.

17. The non-transitory machine readable medium of claim 16, wherein the program further comprises additional sets of instructions for running the trained session utility model on one or more features of an active payment session to predict a probability of a utility of continuing the active payment session.

18. The non-transitory machine readable medium of claim 17, wherein the active payment session comprises at least two consecutive transactions of an active user.

19. A system for customizing a payment session, comprising:
a credential manager subsystem that manages a payment credential;
a service provider subsystem that offers a product; and
a user electronic device that attempts a new purchase of the product of the service provider subsystem, for a user of the user electronic device, using the payment credential, wherein the service provider subsystem is configured to:
detect the new purchase attempt;
in response to the detection of the new purchase attempt, determine that there is an active payment session for the user; and
in response to the determination of the active payment session, run a trained session utility model on one or more features of the new purchase attempt to predict a probability of a utility of continuing the active payment session.

20. The system of claim 19, wherein the service provider subsystem is further configured to:
in response to the prediction of the probability being below a threshold, terminate the active payment session;
add the new purchase attempt to the terminated payment session; and
send all the purchase attempts of the terminated payment session to the credential manager subsystem for authorization.
